(19) United States
(12) Patent Application Publication
(10) Pub. No.: US 2013/0346150 A1
(43) Pub. Date: Dec. 26, 2013

(54) SYSTEM, METHOD, AND COMPUTER PROGRAM PRODUCT FOR FORECASTING SALES

(71) Applicants: Michael Ervin Beddo, Abiquiu, NM (US); Hui Du, Portland, OR (US); Anthony Paul Begg, Santa Fe, NM (US)

(72) Inventors: Michael Ervin Beddo, Abiquiu, NM (US); Hui Du, Portland, OR (US); Anthony Paul Begg, Santa Fe, NM (US)

(73) Assignee: Data Ventures, Inc., Charlotte, NC (US)

(21) Appl. No.: 13/529,926

(22) Filed: Jun. 21, 2012

(51) Int. Cl. G06Q 10/04

(52) U.S. Cl. 705/7.31

(57) ABSTRACT

In general terms, embodiments of the present invention relate to systems, methods, and computer program products for determining forecasting data relating to a product using a neural network and accessing that forecasting data. In some embodiments, a system is provided that includes (a) forecasting apparatus, which stores product information, a data matrix, and a neural network; and (b) a computing system that access the forecasting apparatus via a web portal and transmits some or all of the product information to the forecasting apparatus. In some embodiments, the forecasting apparatus is configured to determine a sales forecast using the product information, data matrix, and neural network and present the sales forecast to the computing system via the web portal.

### BACKGROUND

Product manufacturers and retailers rely on accurate sales forecasts to allocate resources, make strategic business decisions, and evaluate business performance. In nearly every circumstance, the amount of sales of a product is related, at least in part, to the interplay between the price of the product, the advertising for the product, and promotions related to the sale of the product. Additionally, there are an infinite number of other factors, both known and unknown, that influence consumer behavior and ultimately affect the sales of a product.

Various mathematical models have been used to develop sales forecasts. Explanatory models, such as linear regression, are simple models with coefficients that are easy to interpret. However, these models tend not to perform well at predicting because they tend to be too simple. Predictive models attempt to capture the complex dynamics that may exist in a real-world environment, such as a competitive market for goods and services. Nonetheless, they sacrifice interpretability and, thus, may be difficult to explain structure and behavior as readily as explanatory models. Both explanatory and predictive models lack the ability to effectively analyze historical data to learn which factors most greatly influence the sales of a product.

Accordingly, there exists a need for an improved system for providing sales forecasting data that can be used by both manufacturers and retailers of goods. In particular, there exists a need for a system for providing accurate, long-term forecasts based on any number of factors that influence sales. Furthermore, there exists a need for a system that facilitates the collection of data necessary to provide accurate sales forecasts and allows a retailer or manufacturer to easily evaluate how its activities, such as advertising and promotion, may affect the sales of a product. Lastly, there exists a need for a system that is capable of learning which factors have the greatest effect on sales of a product.

### SUMMARY

Embodiments of the invention relate to systems, methods, and computer program products for providing sales forecasts.

In some embodiments, an apparatus is provided that comprises a communication device and a processing device communicably coupled to the communication device, wherein the processing device is configured to: (a) receive first product information, wherein such first product information is at least partially indicative of either the price of the product or consumer demand for the product; (b) generate a first data matrix, wherein the first data matrix comprises at least one variable that represents a portion of the first product information; (c) generate a neural network, wherein the neural network utilizes at least the first data matrix and comprises an input layer, dynamic reservoir, read out layer, and a weighted connection between the read out layer and dynamic reservoir; (d) evaluate the neural network with the first data matrix to determine a first sales forecast; and (e) present the first sales forecast to a user.

In some embodiments of the apparatus, the first product information is provided by the user. In some embodiments of the apparatus, the first product information is provided by at least one third party source. In some embodiments of the apparatus, the first product information comprises information about the price of the product.

In some embodiments, the apparatus is a network device in communication with a computing device of the user. In some of such embodiments, the user is a party that performs at least one of the selling of the product or the manufacturing of the product.

In some embodiments of the apparatus, the processing device is further configured to receive second product information, wherein the second product information comprises at least one of updated information about promotions for the sale of the product, updated information about advertisements for the sale of the product, or updated information about the price of the product.

In some embodiments of the apparatus, the processing device is further configured to generate a second data matrix, wherein the second data matrix comprises at least a portion of the second product information. In some embodiments of the apparatus, the processing device is further configured to generate a second data matrix, wherein the second data matrix comprises at least a portion of the first product information and second product information. In some embodiments of the apparatus, the processing device is further configured to evaluate the neural network with a second data matrix to determine a second sales forecast, wherein the second sales forecast is different than the first sales forecast.

In some embodiments of the apparatus, the processing device is further configured to provide a web portal, wherein the web portal comprises a secure website where a user can perform at least one of the following: upload sales data relating to the product, input descriptions of historical and planned advertisements for the product; input descriptions of historical and planned promotions for the product, or input historical and planned prices for the product.

In some embodiments of the apparatus, the processing device is further configured to dynamically change the neural network based at least in part on the receipt of second product information, wherein the second product information comprises actual sales numbers for the product over the same time period as the first sales forecast.

In some embodiments of the apparatus, the processing device is further configured to permute the value of the at least one variable of the first data matrix to determine the effect of the at least one variable on the first sales forecast.

In some embodiments, a method is provided for providing sales forecasts. The method comprises: (a) receiving first product information, wherein such first product information is at least partially indicative of either the price of the product or consumer demand for the product; (b) generating a first data matrix, wherein the first data matrix comprises at least one variable that represents a portion of the first product information; (c) generating a neural network, wherein the neural network utilizes at least the first data matrix and comprises an input layer, dynamic reservoir, read out layer, and a weighted connection between the read out layer and dynamic reservoir; (d) evaluating the neural network with the first data matrix to determine a first sales forecast; and (e) presenting the first sales forecast to a user.

In some embodiments, a computer program product is provided for providing sales forecasts. The computer program product comprises a non-transitory computer-readable medium, wherein the non-transitory computer-readable medium comprises computer executable program code store therein, the computer executable program code comprises: (a) a first executable portion configured to receive first product information, wherein such first product information is at least partially indicative of either the price of the product or consumer demand for the product; (b) a second executable portion configured to generate a first data matrix, wherein the first data matrix comprises at least one variable that represents a portion of the first product information; (c) a third executable portion configured to generate a neural network, wherein the neural network utilizes at least the first data matrix and comprises an input layer, dynamic reservoir, read out layer, and a weighted connection between the read out layer and dynamic reservoir; (d) a fourth executable portion configured to evaluate the neural network with the first data matrix to determine a first sales forecast; and (e) a fifth executable portion configured to present the first sales forecast to a user.

### BRIEF DESCRIPTION OF THE DRAWINGS

Having thus described some embodiments of the present invention in general terms, reference will now be made to the accompanying drawings, where:

FIG. 1 is a block diagram illustrating a neural network, in accordance with an embodiment of the present invention.

FIG. 2 is a flow diagram illustrating a general process flow for using a neural network to determine forecasting data, in accordance with an embodiment of the present invention.

FIG. 3 is a chart illustrating forecasting data determined through the use of a neural network, in accordance with an embodiment of the present invention.

FIG. 4 is a flow diagram illustrating the use of a neural network to create a feedback loop for dynamically producing forecasting data, in accordance with an embodiment of the present invention.

FIG. 5 is a block diagram illustrating technical components of a system configured for using a neural network to determine forecasting data, in accordance with an embodiment of the present invention.

FIG. 6 is a flow diagram illustrating a general process flow for using a computing system to access forecasting data relating to a product, in accordance with an embodiment of the present invention.

FIG. 7A is part 1 of a mixed block and flow diagram of a system for accessing forecasting data, where the forecasting data has been determined using a neural network, in accordance with an embodiment of the present invention.

FIG. 7B is part 2 of a mixed block and flow diagram of a system for accessing forecasting data, where the forecasting data has been determined using a neural network, in accordance with an embodiment of the present invention. FIG. 7B is a continuation of FIG. 7A.

FIG. 8 is a mixed block and flow diagram of a system for system for accessing forecasting data, where the forecasting data has been determined using a neural network, in accordance with an embodiment of the present invention.

FIG. 9 is a block diagram illustrating a user interface used input product information and access forecasting data, in accordance with an embodiment of the present invention.

### DETAILED DESCRIPTION OF EMBODIMENTS OF THE PRESENT INVENTION

### I. Neural Network Summary and Description

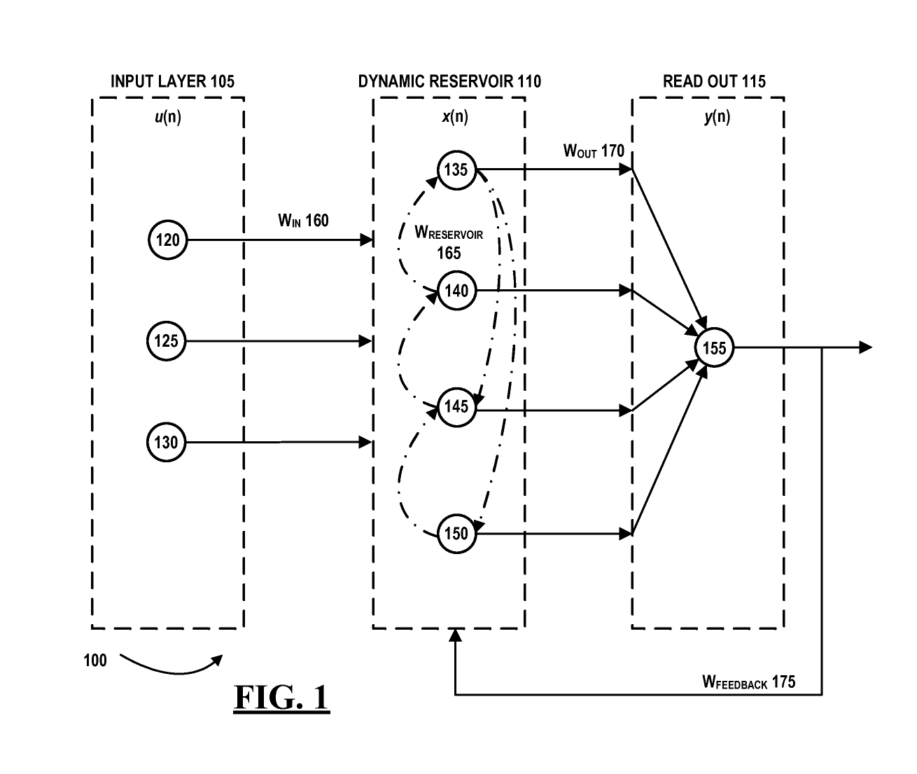

FIG. 1 represents a general depiction of a recurrent neural network, or neural network 100 that is used to determine predictive data, such as forecast data. Neural network 100 comprises an input layer 105, a dynamic reservoir 110, and a read-out 115, which are each designated by the dashed rectangles. Input layer 105 comprises input units 120, 125, and 130, which are each time series non-linear variables, which can comprise current inputs, previous states, and previous outputs. Current inputs are the current values of the variables. Previous states are the historical values of the variables. Previous outputs are the prior predictions of the values of the variables. By having input units 120, 125, and/or 130 comprise previous outputs of the neural network 100, neural network 100 is capable of evaluating the accuracy of its prior predictive data output.

As one of skill in the art will appreciate, input layer 105 may comprise any number of input units and is not limited to the embodiment depicted in FIG. 1. The value of the input layer 105 is represented by the function u(n), which is a mathematical function that represents one or more conditions over a period of time (each condition being an input unit). Input units 120, 125, and 130 are each connected to dynamic reservoir 110 through weighted input matrix Wᵢₙ 160. The weighted input matrix Wᵢₙ 160 provides fit coefficient vectors from the input layer 105 to the dynamic reservoir 110 to obtain generalized cross validation. In other words, neural network 100 is able to identify the input units that represent variables that previously had a greater effect on the predictive output of neural network 100 and, via weighted input matrix Wᵢₙ 160, weigh those input units accordingly. Similarly, neural network 100 is able to identify the input units that represent variables that previously had a lesser effect on the predictive output of neural network 100 and through weighted input matrix Wᵢₙ 160, weigh those input units accordingly.

As one of skill in the art will appreciate, the calculation of weighted input matrix Wᵢₙ 160 is based upon the prior predictive output of neural network 100 and an evaluation of which input units had the greater (and lesser) effects on the predictive output of neural network 100 at an earlier point in time.

Dynamic Reservoir 110 comprises state units 135, 140, 145, and 150, which may be connected to themselves or to others in dynamic reservoir 110, as indicated by the dash-dot lines. Each state unit is the result of the inputs from the weighted input matrix. As one of skill in the art will appreciate, dynamic reservoir 110 may comprise any number of state units and is not limited to the embodiment depicted in FIG. 1. The connections between the state units 135, 140, 145, and 150 are weighted according to weighted reservoir matrix Wᵣₑₛₑᵣᵥₒᵢᵣ 165. Neural network 100 is able to identify the state units that currently have a greater effect on the predictive output of neural network 100 and, via weighted reservoir matrix Wᵣₑₛₑᵣᵥₒᵢᵣ 165, weigh those state units accordingly. Similarly, neural network 100 is able to identify the state units that currently have a lesser effect on the predictive output of neural network 100 and through weighted reservoir matrix Wᵣₑₛₑᵣᵥₒᵢᵣ 165, weigh those state units accordingly.

As one of skill in the art will appreciate, the calculation of weighted reservoir matrix Wᵣₑₛₑᵣᵥₒᵢᵣ 165 is based upon the current state of neural network 100 and an evaluation of which state units have the greater (and lesser) effects on the predictive output of neural network 100 at the current point in time.

The weighted reservoir matrix Wᵣₑₛₑᵣᵥₒᵢᵣ 165 allows for comparison of all variable inputs utilizing time series and training statistical techniques within the neural matrix. The value of the dynamic reservoir 110 is represented by the function x(n), which is the resulting numerical matrix containing predictors and context and hidden layer values for each time step.

Considering a time series of inputs u(n) and corresponding output y(n), for

n=1,2,3, . . . , N,

the algorithm for calculating internal states x(n) is

x(n)=tan h(Wᵢₙu(n)+Wᵣₑₛₑᵣᵥₒᵢᵣ(n−1)+W_{feedback}(n−1))

A state x(n) is a non-linear mixture of inputs, previous states, and the previous outputs. As discussed above, Wᵢₙ 160 provides fit coefficient vectors from the input layer 105 to the dynamic reservoir 110 and Wᵣₑₛₑᵣᵥₒᵢᵣ 165 allows for comparison of all variable inputs utilizing time series and training statistical techniques within the neural matrix. As discussed below, W_{feedback} 175 is a weighted, feedback connection between the output of read-out 115 and dynamic reservoir 110.

The connections between state units 135, 140, 145, and 150 and read out 115 are weighted according to weighted output matrix Wₒᵤₜ 170. Based on both historical and current data, neural network 100 is able to identify the state unit values that have a greater effect on the predictive output of neural network 100 and, via weighted output matrix Wₒᵤₜ 170, weigh those state unit values accordingly. Similarly, based on both historical and current data, neural network 100 is able to identify the state unit values that have a lesser effect on the predictive output of neural network 100 and through weighted output matrix Wₒᵤₜ 170, weigh those state units accordingly. As one of skill in the art will appreciate, Wₒᵤₜ 170 allows for comparison of all variable inputs utilizing time series and training statistical techniques within the matrix, generalized cross validation tests, and rapid training of the neural network. For instance, Wₒᵤₜ 170 allows neural network 100 to identify those state unit values that have the greatest effect on the current predictive output of neural network 100. Additionally, Wₒᵤₜ 170 allows neural network 100 to quickly and efficient adapt to the introduction of new input units into input layer 105. As compared to other known methods of acquiring predictive data (such as linear regression), neural network 100 can be adapted to be used in connection with an infinite number of input units representing an infinite number of non-linear variables.

Read-out 115 comprises output unit 155, which is the output of the neural network. The value of read-out 115 is represented by the function y(n), which is the numerical matrix representing the output of the neural network.

Additionally, neural network 100 also comprises a weighted, feedback connection 175 between the output of read-out 115 and dynamic reservoir 110. Feedback connection 175 is weighted according to weighted feedback matrix W_{feedback} 175. The weighted feedback matrix W_{feedback} 175 provides ability to meta-permutate—that is, to rapidly respond and adapt to incremental inputs as the value of the input layer changes and as the impact to the overall model is determined. Through the use of W_{feedback} 175, neural network 100 changes the relative weights of Wᵣₑₛₑᵣᵥₒᵢᵣ 165 and Wₒᵤₜ 170 based upon the current input units and predictive output of neural network 100. This process actively trains and re-trains the modeling based on the input units and predictive output of neural network 100—thus creating a dynamic system.

Training weights are applied and re-applied as random sparse connections are evaluated. In other words, to the extent real world conditions do not replicate the values on input units 120, 125, and/or 130 and thus do not exactly correlate to the predictive output of neural network 100 for any specific point of time, the values of at least one of Wᵢₙ 160, Wᵣₑₛₑᵣᵥₒᵢᵣ 165, Wₒᵤₜ 170, and W_{feedback} 175 may be changed to properly weigh the input units and state units so as to provide a more accurate predictive data output for subsequent periods of time.

The recurrent neural networks of the present invention (e.g., neural network 100, etc.) typically fix weights after initialization and then dynamically retrain the weights based on subsequent data. Known neural networks do not fully utilize capabilities to provide a more complete methodology, resulting in outputs that resemble linear combination of internal state variables. The dynamic retraining of neural network 100 creates a feedback loop in which data at a hypothetical time t=0 affects the weights of at least one of Wᵢₙ 160, Wᵣₑₛₑᵣᵥₒᵢᵣ 165, Wₒᵤₜ 170, and W_{feedback} 175, which then affects the predictive output of neural network 100 at t=0. Subsequently, as the predictive output at t=0 is compared to the data a time t=1, the feedback loop starts again and the weights of at least one of Wᵢₙ 160, Wᵣₑₛₑᵣᵥₒᵢᵣ 165, Wₒᵤₜ 170, and W_{feedback} 175 are readjusted. Thus, unlike linear predictive models and other types of neural networks, which can only provide predictive results assuming basic conditions remain the same, the neural network of the present invention (e.g., neural network 100, etc.) is capable of dynamically adjusting due to changing conditions (or the addition or removal of conditions) and can continue to provide accurate predictive data.

### II. Method of Calculating Forecasting Data Using a Neural Network

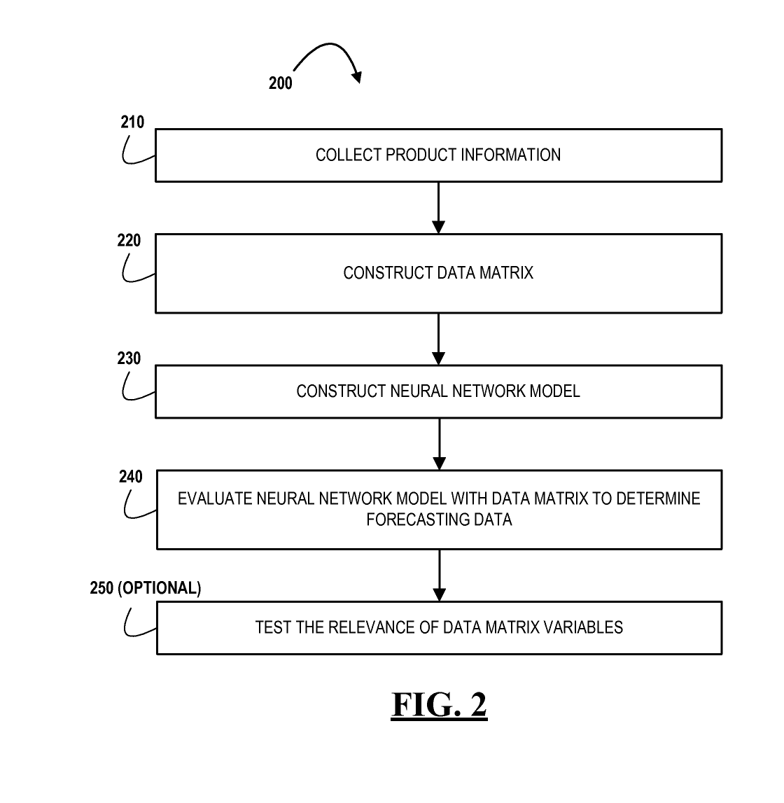

Referring now to FIG. 2, a general process flow 200 is provided for determining forecasting data using a neural network. In some embodiments, one or more portions of process flow 200 is performed by one or more apparatuses having hardware and/or software configured to perform such portions of process flow 200. As represented by block 210, process flow 200 includes the step of collecting product information. As represented by block 220, process flow 200 includes the step of constructing a data matrix. In addition, as represented in block 230, process flow 200 includes the step of constructing a neural network model. Process flow 200 also includes the step of evaluating the neural network model with the data matrix to determine forecasting data, as represented by block 240. Lastly, as represented by block 250, process flow 200 includes the optional step of testing the relevance of data matrix variables.

The term “determine,” in some embodiments, is meant to have one or more of its ordinary meanings, but in other embodiments, that term is meant to have one or more of the ordinary meanings of one or more of the following terms: decide, conclude, verify, ascertain, obtain, find, discover, learn, calculate, observe, read, and/or the like.

It will also be understood that the apparatus configured to perform all or portions of process flow 200 can include one or more separate and/or different apparatuses. For example, in some embodiments, one apparatus is configured to perform all of the portions of process flow 200 represented by blocks 210-250. It will also be understood that, in some other embodiments, different apparatuses are configured to perform one or more portions of process flow 200. For example, in some embodiments, one computing system could be configured to perform portions of process flow 200 represented by blocks 210-230 and another computing system could be configured to perform portions of process flow 200 represented by blocks 240-250.

Additionally, it will be understood that process flow 200 can be performed by any type of individual or entity. In some embodiments, a company (e.g., manufacturer, retailer, etc.) may perform process flow 200 and in other embodiments, an individual may perform process flow 200. Additionally, the individual or entity that performs process flow 200 may perform it on behalf of any other individual or entity.

Regarding block 210, the phrase “product information” means any type of information associated with the sale of a product. In some embodiments, the product information is associated with the sale of a product by a retailer (e.g., a grocery store, big box retailer, retail website, etc.) to a consumer. Where the product information is associated with the sale of a product by a retailer (or any other entity with multiple locations), the product information may be associated with sales of a product by the retailer as a whole, sales of a product by an individual store, sales of a product by a group of stores, or sales of a product by any other groups of locations of the retailer (e.g., geographic groupings, size groupings, etc.). In other embodiments, the product information is associated with the sale of a product manufactured by a manufacturer. In other embodiments, the product information is associated with the sale of a product by any other individual or type of entity.

The product information may relate to the sale of any type of product or products. In some embodiments the product information relates to the sale of a single, specific product (e.g., Brand X consumer product) or products (e.g., consumer products manufactured by Company Y). In other embodiments, the product information relates to the sale of a product category (e.g., beverages). The product information may relate to the sale of any type of product, including consumer goods (e.g., groceries, electronics, clothing, etc.), business goods (e.g., raw materials, industrial supplies, etc.) or any other type of good.

The product information can be any amount or type of information associated with the sale of a product. For example, the product information may comprise “sales data”, which as used herein, means the number of units sold during any time period (e.g., hours, weeks, days, months, years, etc.). The sales data could describe the number of units sold by a certain individual or company and/or it may describe the number of units sold by other participants in the market, such as that individual's or company's competitors.

The product information may also comprise the unit price at which a product is sold (or planned to be sold) by a certain individual or company. Additionally, the product information may comprise the price at which other participants in the market sold (or plan to sell) the product.

The product information may also comprise information about advertisements and/or promotions associated with the product. For example, the product information may include information indicating that the following types of advertisements were in effect when products were sold: print advertisements; television advertisements; radio advertisement; in-store advertisements; internet advertisements; billboards; or any other types of advertisements that might be relevant to the sale of the product. Additionally, the product information may comprise information indicating that the following types of promotions that were in effect when products were sold: buy a certain quantity of products to get a certain price; buy a certain quantity of products to get a certain number free; daily, weekly, or monthly special prices; promotions through the use of certain payment methods; promotions through the use of customer loyalty cards; or any other types of promotions that might be relevant to the sale of a product. Additionally, the product information may comprise information about advertisements and/or promotions that are run by other companies and/or individuals selling the product.

As one of skill in the art will appreciate, the product information may also comprise any other type of information that describes conditions that affect the sale of a product. For instance, product information may include information about weather conditions (e.g., temperature, humidity, snowfall, etc.), raw materials prices, gasoline prices, the occurrence of holidays (e.g., Thanksgiving, Fourth of July), the occurrence of special events (e.g., festivals, sporting events, etc.), information about product supply chains, population statistics (e.g., demographics data, population size data, population growth data, etc.), economic data (e.g., consumer spending, GDP, mean annual income, stock market prices, etc.), sponsorship data, or any other condition that might affect the price of a product or consumer demand for a product.

The product information may be historical information, it may be prospective information, or it may be a combination of both. For example, the product information could comprise historical sales data, information about advertisements that were in effect in the past, information about promotions that were in effect in the past, or information about past weather conditions. Additionally, the product information could comprise prospective information about advertisements or promotions that a company or individual would like to run in the future. For example, the product information could comprise information indicating that in the third financial quarter of a given year, a retailer plans to run successive newspaper advertisements and loyalty card promotions for a given product.

The product information may be associated with the sales of the product or it may be associated with the sales of another product. For instance, product information associated with the sale of Brand #1 consumer product may comprise information associated with the sale of Brand #2 consumer product, where Brand #1 and Brand #2 are (i) competitive brands of the same type of consumer product and exist within the same competitive selection set; or (ii) complementary products, such as a children's beverage and snack food; or (iii) inverse products, such that the sale of Brand #2 replaces a need to buy Brand #1. Examples of information associated with a Brand #2 consumer product that comprise product information associated with Brand #1 consumer product include, but are not limited to, the unit price of Brand #2 consumer product, types of advertisements for Brand #2 consumer product, and types of promotions for Brand #2 consumer product. Additionally, product information may comprise information associated with the sale of the product in different sizes (e.g., 12 oz v. 24 oz, number of washloads, etc.), package or size configurations (e.g., 12 pack v. 24 pack, bundle packs, etc.), or varieties (e.g., diet variety, low-carb variety, etc.).

The product information may be determined based upon numerous sources. All or portions of the product information may be determined based upon a company's or individual's sales records or point-of-sale data (e.g., what was sold, when was it sold, at what price was it sold, etc.). All or portions of the product information may also be determined using information obtained through the use of customer loyalty cards or check-out data. All or portions of the product information may also be determined using third party information, including but not limited to industry reports, consulting reports, trade association data, government data, news sources, subscription services, etc. In some embodiments, such third party information may comprise a third party data feed.

Although the preceding description of product information discloses embodiments in which the product information is information associated with the sale of products by a retailer to a consumer, the product information could also any type of similar information associated with the sale of products by one business to another business.

The collection of product information, as represented by block 210, can occur in any fashion using any type of communication medium. In some embodiments, the collection of product information occurs through the use of an electronic communication network. As one of skill in the art will appreciate, the electronic communication network may be any type of communication network, such as a wireless or wired communication network. The communication network may be a cellular network (e.g., 2G, 3G, 4G network) or it may be a non-cellular network, such a wireless local network (WLAN), global area network (GAN), a wide-area network (WAN), the Internet, and/or other communication/data networks. In some embodiments, the collection of product information occurs through the use of a website that facilitates the collection of product information. For example, a retailer may access a website to upload or otherwise transmit the sales data to the individual or entity that is performing process flow 200. In yet other embodiments, the product information may relate to sales of a product made by the individual or entity that performs process flow 200 and the collection of product information may involve storing and organizing the product information in a central location in any usable format. In other embodiments, an individual or entity that is performing process flow 200 can retrieve or receive product information from one or more third parties, such as a retailers, manufacturers, third party subscription services, etc. In such an embodiment, the collection of product information occurs by retrieving or receiving the product information from the entity or entities that store product information. Such retrieval or reception could occur automatically or upon indication from the individual or entity performing process flow 200.

Block 220 represents the construction of a data matrix. As used herein, the term “data matrix” refers to any organization of product information that is to be used in connection with a neural network to determine forecasting data. Constructing the data matrix involves performing any operation to organize the product information so that it can be used in connection with the neural network. Constructed within array or other database structure, the data matrix comprises product information relating to the product for which a user desires to determine forecasting data. Constructing the data matrix could involve calculations with product information, centering the values of the product information (i.e., taking a standard deviation, etc.), scaling the values of the product information, or performing any other function to transform and/or normalize the product information so that it can be used in connection with the neural network. As constructed, the data matrix represents a series of variables, where each variable represents a portion of the product information. For example, a data matrix could be constructed that includes the following variables: the price that a certain product was sold during a given week, whether or not there were radio advertisements for the product during a given week, the high temperature during the given week, and the type of promotion that was being run for the product during the given week. These variables, when inputted into the neural network, are used to determine the forecasting data.

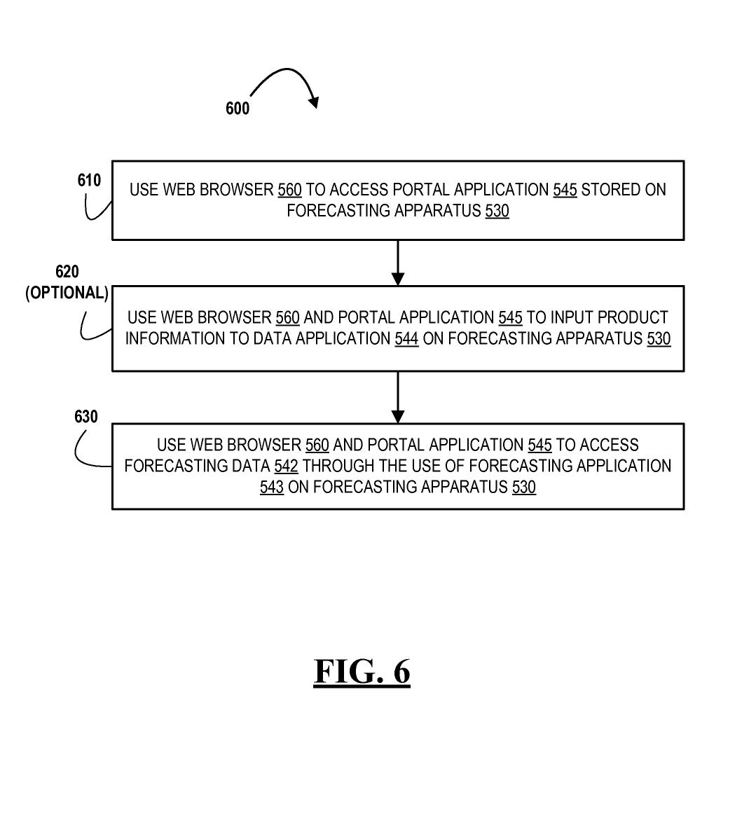

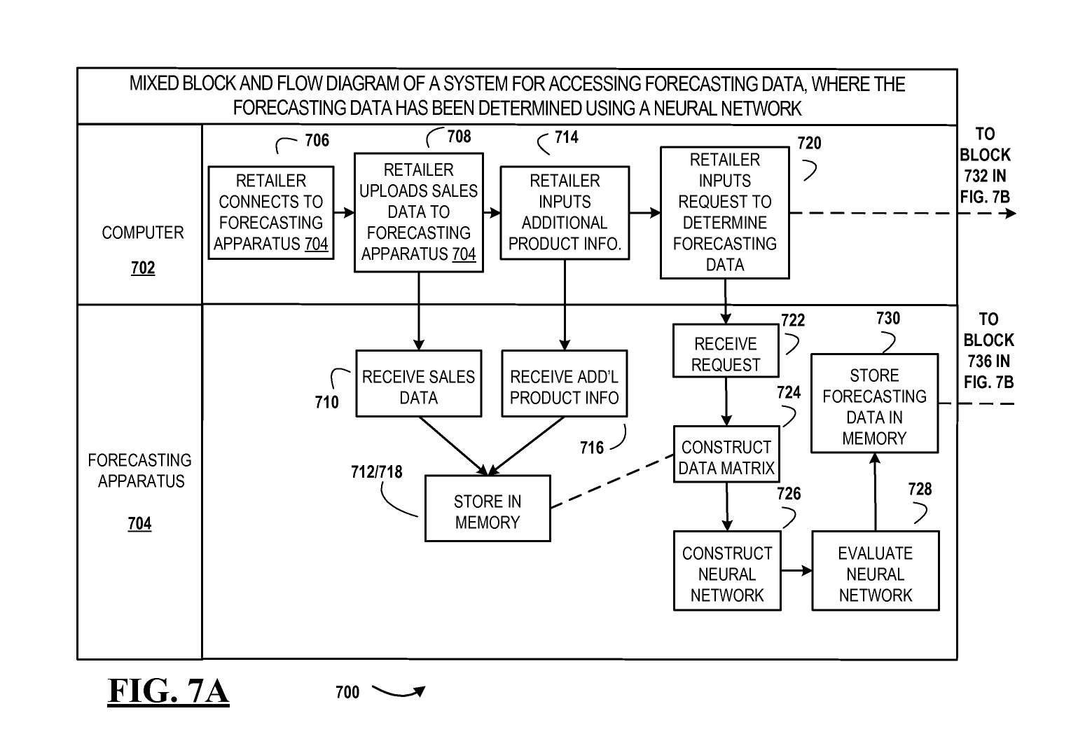

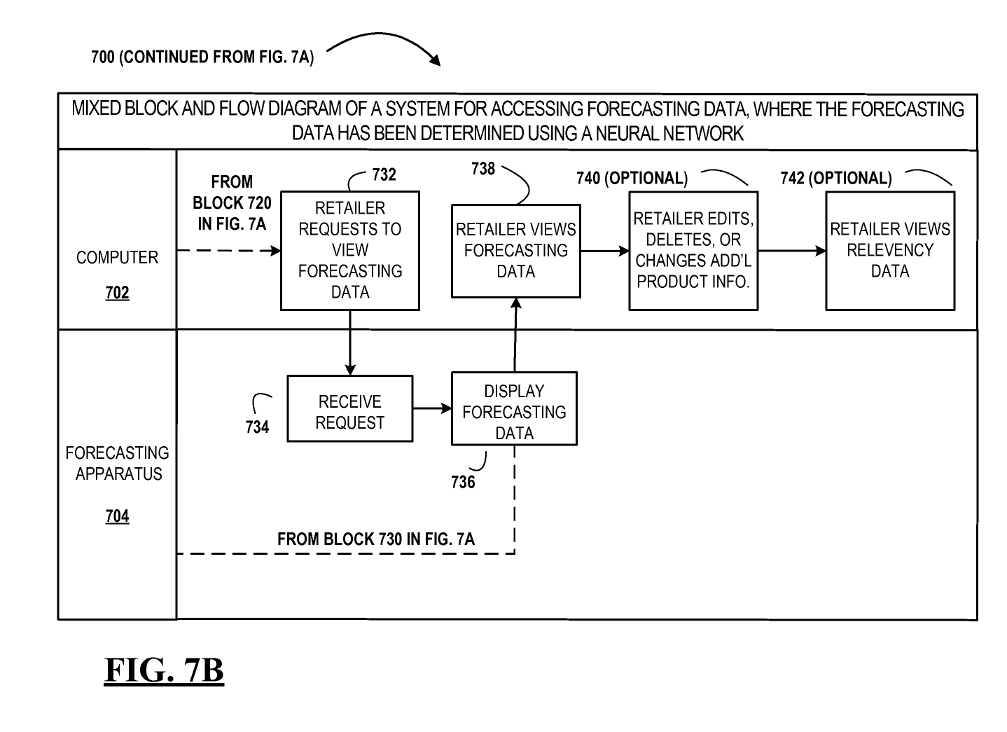

Although not illustrated in FIG. 2, in some embodiment, the process of constructing the data matrix from product information involves the use of a website, such as described in connection with FIG. 6 and FIG. 7. In such embodiments, a user could input product information through the use of a website (i.e., through the use of text input boxes and other web elements) and the website could automatically transform, normalize, and/or format such product information into the data matrix.

At block 230, a neural network is constructed in accordance with the description set forth above. Specifically, process flow 200 includes the construction of a neural network as described in connection with FIG. 1.

At block 240, the neural network is evaluated using the data matrix to produce the forecasting data. Through the use of mathematical transformations, this data matrix can be transformed into a format that can be used in connection with the input units of the neural network input layer 105.

Lastly, block 250 represents the optional step of testing the relevance of each input variable of the data matrix to the forecasting data obtained at step 240. Block 250 involves freezing the values of all of the input variables except one, and permuting the value of the one “non-frozen” variable. As one of skill in the art will appreciate, the amount by which the output value of the neural network changes as the non-frozen variable is permuted is a measure of the relevance of the non-frozen variable to the forecasting results.

Although not disclosed in connection with FIG. 2, it should be understood that after the completion of block 240, process flow 200 may include the steps of collecting additional product information, constructing a new data matrix (that includes the additional product information), and evaluating the neural network model with the new data matrix to determine new forecasting data.

Due to the structure of the neural network used in the present invention, the present invention is able to effectively identify which data matrix variables are relevant to forecasting the sales of a product (or any other trends) during any given period of time. For example, for a sales forecast describing the sales of a certain consumer product, the neural network of the present invention may identify that a variable representing the presence of Internet advertisements for that consumer product has the greatest effect on sales, whereas the variable representing the price at which the consumer product is sold has the smallest effect on sales. In this manner, the neural network of the present invention is able to identify critical factors that influence the sales of a product, where those factors might not otherwise be apparent to the company or individual making the sales. Additionally, the structure of the neural network used in the present invention allows the neural network to improve the forecasting data based upon the input of additional product information. As the neural network processes a greater amount of product information, it is configured to adapt and learn which variables in the data matrix have the greatest impact on the accuracy of the forecasting data. Thus, the use of product information over a greater period of time and the use of product information comprising more variables will have the effect of increasing the accuracy of the forecasting data. As described in connection with FIG. 1, this process of adapting and learning requires that the neural network have the ability to meta-permutate—that is, to rapidly respond to incremental inputs as environmental conditions change, as the impact to the overall model is determined A dynamic system is created through the active training and re-training of neural network connections, which distinguishes the neural network of the present invention of other known methods and leads to improved forecast outputs.

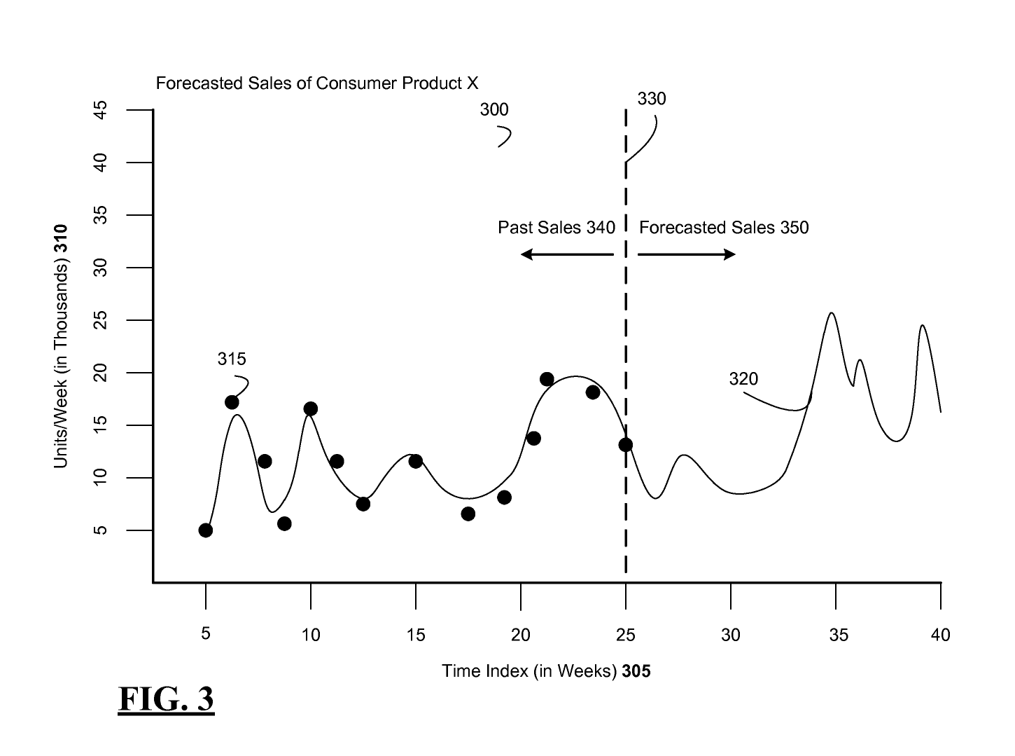

FIG. 3 represents a set of forecasting data 300 determined by using process flow 200. Forecasting data 300 forecasts the sales of Consumer Product X over a forty (40) week period. Forecasting data 300 comprises forecasting curve 320 and is displayed on a graph where the x-axis 305 represents a time index and the y-axis 310 represents the number of units sold per week. Forecasting data 300 also comprises data points 315, which are sales data that represent units of Consumer Product X that were sold during weeks 1 to 25. These data points comprise a portion of the product information that was used in connection with a neural network to determine forecasting curve 320 using the method described in connection with process flow 200. Dashed line 330 is located at a point along x-axis 305 to indicate the present time. Thus, the data points 315 to the left of dashed line 330 represent past sales 340 and the portion of forecasting curve 320 to the right of dashed line 330 represent forecasted sales 350. Thus, as represented by forecasting curve 320, forecasting data 300 is a sales forecast that can be used to forecast the number of units of Consumer Product X that are to be sold in future weeks (i.e., weeks 25 to 40) based on the sales data. Through use of neural network 100, specific future week demand forecast predictions for Consumer Product X can be achieved which are derived from neural net inputs of product information associated with Consumer Product X, while accounting for prediction error and unknowns. As represented by forecasting curve 320, the resulting output can be graphed and utilized for predictive benefit for future comparative weeks, merchandising types, and competitive comparisons of Consumer Product X. For example, a retailer can look at forecasting curve 320 to evaluate whether it needs to make changes to its pricing plan for Consumer Product X, advertising plan for Consumer Product X, or promotion plan for Consumer Product X in order to achieve greater sales. Furthermore, a sales forecast that is less than expected for a given set of pricing, advertising, and promotion plans may indicate that there are other factors, unknown to the retailer, that affect that future sales of Consumer Product X.

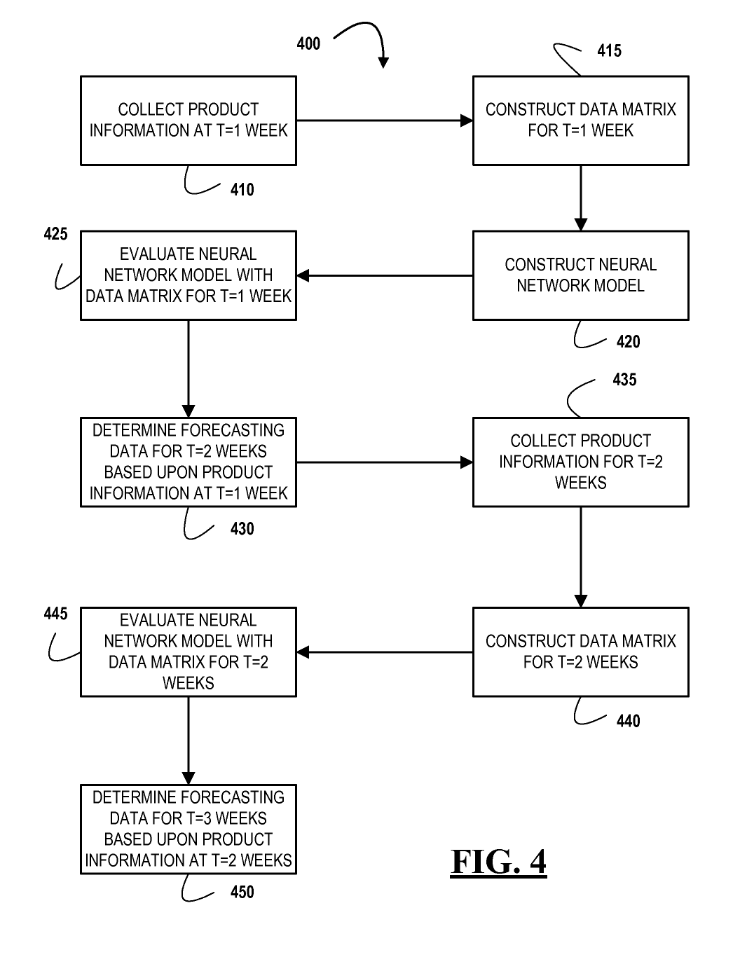

Referring now to FIG. 4, a process flow 400 is provided that illustrates how the neural network of FIG. 1 can be used in connection with the process of FIG. 2 to create a feedback loop for dynamically producing forecasting data. In some embodiments, one or more portions of the process flow 400 are performed by an apparatus having hardware and/or software configured to perform one or more portions of the process flow 400. In some of these embodiments, the apparatus configured to perform the process flow 400 is also configured to perform the process flow 200. As such, it will be understood that the process flow 400 illustrated in FIG. 4 represents an embodiment of the process flow 200 described in connection with FIG. 2.

At block 410 the system collects product information at T=1 week. In this embodiment of the invention, the variable “T” represents time and product information at T=1 week represents product information for the sale of a Consumer Product B over the course of a first week. As discussed in connection with FIG. 2, product information may be any type of information associated with the sale of the Consumer Product B. However, in this embodiment of the invention, the product information at T=1 week represents the pricing of the Consumer Product B during the first week, the types of advertisements ran for Consumer Product B during the first week, the types of promotions ran for Consumer Product B during the first week, and the number of sales of Consumer Product B during the first week.

At block 415, a data matrix is constructed using the product information at T=1 week. Constructing the data matrix could involve calculations with product information, centering the values of the product information (i.e., taking a standard deviation, etc.), scaling the values of the product information, or performing any other function to transform and/or normalize the product information so that it can be used in connection with the neural network.

At block 420, a neural network model is constructed, which is an embodiment of the neural network described in connection with FIG. 1. As previously discussed in connection with FIG. 1, the neural network has an input layer, dynamic reservoir, and read out layer. A weighted input matrix applies weights to the connections between the input layer and dynamic reservoir. A weighted reservoir matrix applies weights to the connections between the state units of the dynamic reservoir. Lastly, a weighted output matrix applies weights to the connections between the state units of the dynamic reservoir and the read out layer. Lastly, as described in connection with FIG. 1, the neural network created at block 420 contains a feedback connection between the read out layer and the dynamic reservoir. As described in connection with FIG. 1 the weights between connections in the neural network are assigned based upon the effect certain pieces of product information (e.g., prices, advertisement, promotions, etc.) have on the overall sales of Consumer Product B.

At block 425, the neural network (as constructed at block 420) is evaluated with the data matrix for T=1 week. In this embodiment of the invention, the use of mathematical transformations transforms the data matrix into a format that can be used in connection with the input units of the neural network input layer. At block 430, the neural network determines forecasting data for T=2 weeks based on the data matrix for T=1 week. As described herein, the forecasting data for T=2 week means sales forecast for Consumer Product B during a second week that immediately follows the first week. In this embodiment of the invention, the forecasting data for T=2 weeks is constructed just prior to the beginning of the second week.

At block 435 the system collects product information at T=2 weeks. In this embodiment of the invention, the product information at T=2 weeks represents product information for the sale of a Consumer Product B over the course of the second week. In this embodiment of the invention, the product information at T=2 weeks represents the pricing of the Consumer Product B during the second week, the types of advertisements ran for Consumer Product B during the second week, the types of promotions ran for Consumer Product B during the second week, and the number of sales of Consumer Product B during the second week. Furthermore, the product information at T=2 also includes information that was not included in the product information at T=1, namely the average temperature for each day during that week.

At block 440, a data matrix is constructed using the product information at T=2 weeks. Constructing the data matrix at block 440 occurs in the same manner as constructing the data matrix at block 415. The data matrix using product information at T=2 will differ from the data matrix using product information at T=1 because it will also include the information relating to the average temperature during each day of the second week.

At block 445, the neural network (as constructed at block 420) is evaluated with the data matrix for T=2 weeks. In this embodiment of the invention, the use of mathematical transformations transforms the data matrix into a format that can be used in connection with the input units of the neural network input layer. During the evaluation of the neural network at block 445, the weights between connections in the neural network are evaluated and if necessary, re-valued based upon at least (1) the previous weights assigned at block 420, (2) the product information at T=2 weeks, and (3) a comparison of how the data forecast for T=2 weeks (as calculated at block 430) compares to the actual number of sales of Consumer Product B during the second week. Additionally, at block 445 new weights are created based upon the calculated effect that the average daily temperature had on the sale of Consumer Product B during the second week.

At block 450, the neural network determines forecasting data for T=3 weeks based on the data matrix for T=2 weeks. As described herein, the forecasting data for T=3 weeks means sales forecast for Consumer Product B during a third week that immediately follows the second week. At block 450, this forecasting data also takes into account the information about average daily temperature, which was first collected at block 435. In this embodiment of the invention, the forecasting data for T=3 weeks is constructed just prior to the beginning of the third week.

The process flow depicted in FIG. 4 can continue indefinitely, thus creating a feedback loop for dynamically producing forecasting data in which the neural network is evaluated with current product information. During the evaluation process, connections within the neural network (which are determined based upon previous product information and previous forecasting data) are re-valued based upon the current product information to create forecasting data for a later period in time. As described in connection with FIG. 4, the neural network of the present invention is capable of creating updated forecasting data based on the addition, subtraction, or changing of product information. Thus, unlike linear predictive models and other types of neural networks, which can only provide predictive results assuming basic conditions remain the same, the neural network of the present invention is capable of dynamically adjusting due to changing conditions (or the addition or removal of conditions) and can continue to provide accurate predictive data.

Although the embodiment of the invention described in connection with FIG. 4 is one in which product information is collected on a weekly basis and forecasting data is determined on a weekly basis, in other embodiments, such collection of product information and determination of forecasting data may occur at any other time interval (e.g., hourly, weekly, monthly, or continuously).

### III. System for Determining Forecasting Data Using a Neural Network

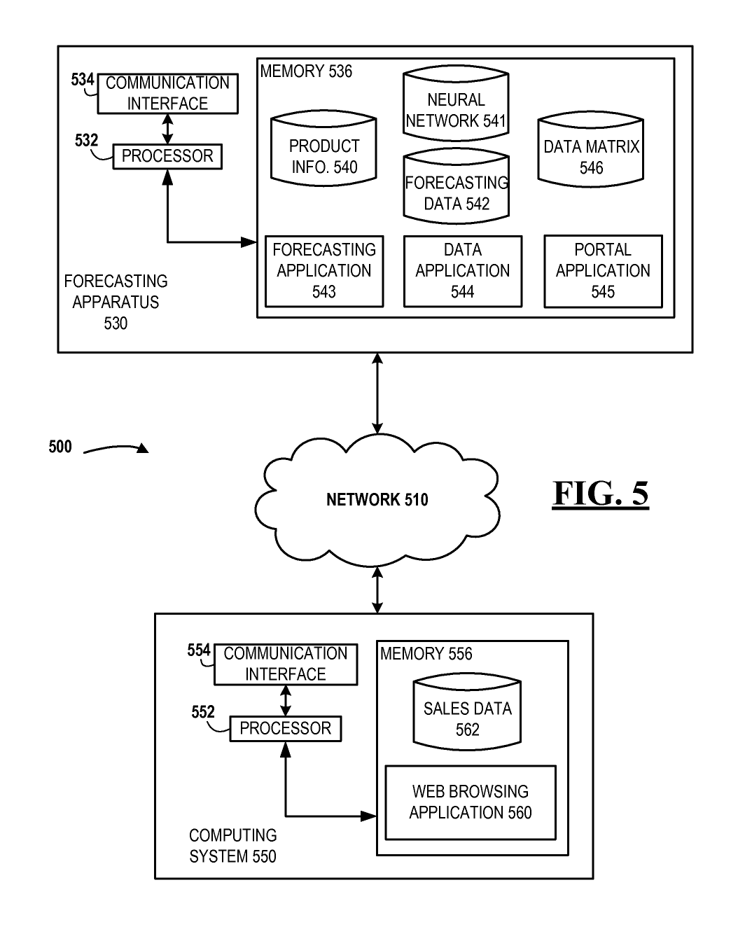

Referring now to FIG. 5, a system 500 is illustrated for obtaining forecasting data using a neural network. As illustrated system 500 includes network 510, a forecasting apparatus 530, and optionally, a computing system 550.

The forecasting apparatus 530 generally includes a processor 532 communicably coupled to such devices as communication interface 534 and memory 536. The processor 532 and other processors described herein may generally include circuitry for implementing communication and/or logic functions of the forecasting apparatus 530. For example, the processor 532 may include a digital signal processor device, a microprocessor device, and various analog to digital converters, digital to analog converters, and/or other support circuits. Control and signal processing functions of the forecasting apparatus 530 may be allocated between these devices according to their respective capabilities. The processor 532 thus may also include the functionality to encode and interleave messages and data prior to modulation and transmission. The processor 532 may additionally include an internal data modem. Further, the processor 532 may include functionality to operate one or more software programs or applications, which may be stored as computer-readable code in the memory 536.

The processor 532 may be configured to use the communication interface 534 to communicate with one or more other devices on a network. The processor 532 may be configured to provide signals to and receive signals from the communication interface 534. The forecasting apparatus 530 may be configured to operate in accordance with second-generation (2G) wireless communication protocols, third-generation (3G) wireless communication protocols, fourth-generation (4G) wireless communication protocols, and/or the like. The forecasting apparatus 530 may also be configured to operate in accordance with non-cellular communication mechanisms, such as via a wireless local area network (WLAN), global area network (GAN), a wide-area network (WAN), the Internet, and/or other communication/data networks.

As further illustrated in FIG. 5, the forecasting apparatus 530 includes the memory 536. In some embodiments, the memory 536 contains information stored therein, such as product information 540, neural network 541, forecasting data 542, and data matrix 546. Product information 540 comprises the product information that is formed into a data matrix 546 and imputed into the neural network 541 to determine forecasting data 542. Neural network 541 comprises the neural network that processes data matrix 546 to determine forecasting data 542. Memory 536 may also comprise forecasting application 543 and data application 544, which each include computer code that, when executed by the processor 532, perform one or more of the functions described herein in relation to forecasting apparatus 530. In some embodiments, data application 544 and forecasting application 543 are web-based applications that can be accessed by a third party via network 510. In some embodiments, data application 544 is configured to perform functions relating to blocks 210 and 220 of process flow 200 and forecasting application 543 is configured to perform functions relating to blocks 230, 240, and 250 of process flow 200. The forecasting apparatus 530 may be maintained by a third-party service provider, retailer, and/or any other entity that wishes to provide the functionality described herein. Memory 536 may also include optional portal application 545. Portal application 545 includes computer code that when executed by processor 532 enables a remote user to (i) upload and/or input product information to forecasting apparatus 530 by remotely accessing data application 544; (ii) review forecasting data 542 by remotely accessing forecasting application 543; and (iii) and perform other functionality as described herein. In some embodiments of the invention, a retailer accesses portal application 545 to input product information 540 (such as sales data, an indication of planned advertisements for a product, and/or an indication of planned promotions for a product) in order to evaluate how this product information affects the forecasting data 542. In other embodiments, an entity involved in the supply chain of a product (e.g., manufacturer), may access portal application 545 to see the forecasting data 542 for a product in order to anticipate and plan for the manufacturing of the quantity of product identified in the forecasting data 542. In some embodiments of the invention, portal application 545 may be accessible over the Internet via a web browser, where the portal application provides a web portal to access the functionality of forecasting apparatus 530. The web portal may require the use of some type of authentication mechanism, such as a username and password combination, digital certificate, or other security functionality. In other embodiments, portal application 545 may be accessible be executing a software application installed on a remote computing device, a mobile application installed on a mobile computing device, or any other method known to one skilled in the art.

While FIG. 5 depicts an embodiment of the invention in which product information 540, neural network 541, forecasting data 542, data matrix 546, data application 544, and forecasting application 543 are all stored in memory 536, in other embodiments, some or all of the data and applications depicted in memory 536 may be stored in a separate memory device that is communicably connected to forecasting apparatus 530 over a wired or wireless communication network, such as network 510. Further, the separate memory device may be stored in an apparatus that is different than the forecasting apparatus 530.

In some embodiments of the invention, forecasting apparatus 530 may be used to calculate forecasting data for multiple individuals or entities. Although not illustrated in FIG. 5, in such an embodiment, memory 536 may store the product information for multiple different entities or individuals (e.g., Retailer 1 and Retailer 2). To the extent the product information of one entity (for example, Retailer 1) may be relevant to the sales of a product by another entity (for example, Retailer 2), forecasting apparatus 530 may be configured to access Retailer 1's product information as part of determining forecasting data for Retailer 2. In such an embodiment, forecasting apparatus 530 may be configured to not display or otherwise disclose Retailer 1's product information to Retailer 2.

As indicated in FIG. 5, the network 510 may include one or more telephone networks (e.g., cellular networks, CDMA networks, any wireline and/or wireless network over which communications to telephones and/or mobile phones are sent), local area networks (LANs), wide area networks (WANs), global area networks (GANs) (e.g., the Internet), and/or one or more other telecommunications networks. For example, in some embodiments, the network 520 includes a wireless global area network.

Optional computing system 550 is a computing system configured to communicate with forecasting apparatus 530 over network 510. Computing system 550 may be operated by an individual or entity that seeks to access forecasting data 542 from forecasting apparatus 530. Computing system 550 generally includes a processor 552 communicably coupled to such devices as communication interface 554 and memory 556. The processor 552 may be configured to use the communication interface 554 to communicate with one or more other devices on a network. The processor 552 may be configured to provide signals to and receive signals from the communication interface 554. Computing system 550 may be configured to operate in accordance with second-generation (2G) wireless communication protocols, third-generation (3G) wireless communication protocols, fourth-generation (4G) wireless communication protocols, and/or the like. Computing system 550 may also be configured to operate in accordance with non-cellular communication mechanisms, such as via a wireless local area network (WLAN), global area network (GAN), a wide-area network (WAN), the Internet, and/or other communication/data networks.

As further illustrated in FIG. 5, the computing system 550 includes the memory 556. In some embodiments, the memory 556 contains data stored therein, such as sales data 562. Sales data 562 comprises information and/or data indicating the number of units sold of a product during any time period and is transmitted to forecasting apparatus 530 to use in connection with data application 544 and forecasting application 543. Sales data 562 may comprise all or portions of product information 540. Memory 556 may also comprise web browsing application 560, which includes computer code that, when executed by the processor 552, allows computing system 550 to access websites via network 510. In some embodiments, web browsing application 560 is configured to access portal application 545.

### IV. Methods of Using Forecasting Apparatus

### A. Generally

Referring now to FIG. 6, a process flow 600 is provided for using computing system 550 to access forecasting data relating to a product, where the forecasting data is determined by forecasting apparatus 530. Process flow 600 may be performed by any entity that wishes to access forecasting data relating to a product. In some embodiments of process flow 600, a user, such as a retailer, uses computing system 550 to connect to forecasting apparatus 530, which is operated and maintained by another party, such as a consultant. In other embodiments, both computing system 550 and forecasting apparatus 530 are maintained by the user, such as a retailer. In some embodiments where the retailer comprises numerous stores, forecasting apparatus 530 may be maintained by a general or corporate office that represents the numerous stores.

The term “access” is meant to have one or more of its ordinary meanings, but in other embodiments, that term is meant to have one or more of the ordinary meanings of one or more of the following terms or phrases: view, display, obtain, interact with, connect to, and/or control.

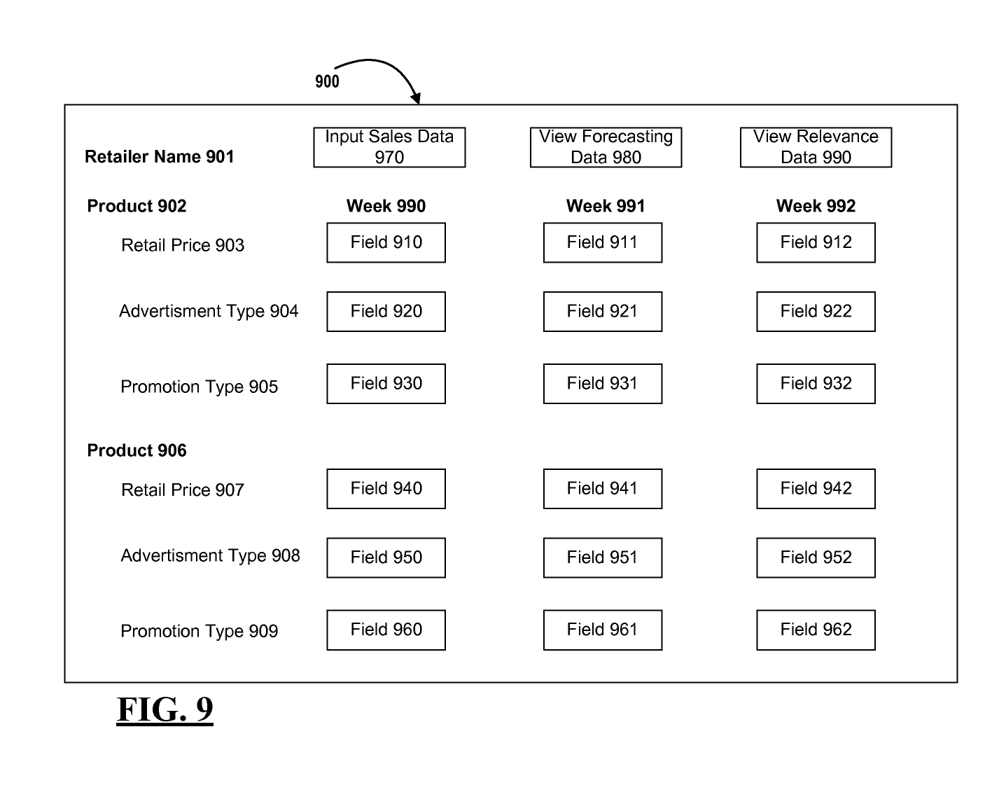

Regarding block 610, the user uses web browser 560 to access portal application 545 of forecasting apparatus 530. Portal application 545 allows the user to upload all or portions of sales data 562 to forecasting apparatus 530, as well as access data application 544 and/or forecasting application 543. Portal application 545 presents the user with a web-based interface to input sales data, input information relating to advertisements and promotions (as well as any other type of product information), view forecasting data, and/or perform other functionality described herein. Embodiments of the web-based interface of portal application 545 will be described in greater detail in connection with FIG. 9.

Regarding optional step represented by 620, the user uses web browser 560 and portal application 545 to input product information to data application 544. In some embodiments of block 602, the product information may comprise sales data 562. Portal application 545 enables the user to upload all or a portion of sales data 562 to data application 544, where it is subsequently stored in memory 536. Portal application 545 may also enable the user to input product information that comprises information about advertisements and promotions relating to a product. For example, portal application 545 may provide the user with a graphical user interface through which the user can input the type advertisements and promotions that were being run when the product was sold. Additionally, portal application 545 may provide the user with a graphical user interface through which the user can input information about prospective advertisement and promotions that the user expects to run in connection with the sales of a product. The information that the user inputs regarding advertisements and promotions is provided to data application 544. Additionally, any sales data 562 that is uploaded to forecasting apparatus 530, as well as any product information (such as imputed information regarding advertisement and promotions), is stored as product information 540 on forecasting apparatus 530 and used by data application 544 to construct data matrix 546 pursuant to the method of FIG. 1. Additionally, portal application 545 may provide the user with a graphical user interface through which the user can input any other type of product information such as, weather conditions (e.g., temperature, humidity, snowfall, etc.), raw materials prices, gasoline prices, the occurrence of holidays (e.g., Thanksgiving, Fourth of July), the occurrence of special events, information about product supply chains, population statistics (e.g., demographics data, population size data, population growth data, etc.), economic data (e.g., consumer spending, GDP, mean annual income, stock market prices, etc.), sponsorship data, or any other condition that might affect the price of a product or consumer demand for the product.

Regarding block 620, it should be understood that the user can input any type of product information, which, as discussed in connection with FIG. 2, can be any amount or type of information associated with the sale of a product. Additionally, regarding block 620, it should be understood that portal application 545 may provide the user with a single graphical user interface through which the user can input product information or multiple graphical user interfaces through which the user can input product information (i.e., a different graphical user interface for each type of product information).

At block 630, the user uses web browser 560 and portal application 545 to access forecasting data 542 using forecasting application 543. As described in relation to FIG. 2 and FIG. 5, forecasting application 543 is configured to construct a neural network model and evaluate the neural network model using data matrix 546 to determine forecasting data 542. As described herein, at block 630, forecasting application allows the user to view the forecasting data 542. In some embodiments of the invention, the forecasting data 542 is displayed to the user over a web-based interface in the format described in connection with FIG. 3. Thus, the forecasting data is displayed as a graph that shows the number of units of product that are forecasted to be sold as a function of time. However, it should be understood that in other embodiments, forecasting data 542 can be displayed in different formats, such as a bar graph, raw data, or any other format known to one of skill in the art. Additionally, at block 630, the user may use portal application 545 to perform other functionality, such as test the relevance of input variables, as described in connection with block 250 of FIG. 2, send the forecasting data 542 to third parties, or incorporate the forecasting data 542 into the user's business systems.

As discussed above, FIG. 6 represents a process flow in which a user using computing system 550 remotely accesses forecasting apparatus 530 to optionally input product information and access forecasting data, where the forecasting data is determined by forecasting apparatus 530. As one of skill in the art will appreciate, a user may alternatively directly access forecasting apparatus 530 or any other computer system having equivalent functionality. In such an embodiment, the user may directly input product information to forecasting apparatus 530 or such product information, such as sales data, may already be stored on or accessible via forecasting apparatus 530.

### B. Example No. 1

### Use by Retailer

Referring now to FIGS. 7A and 7B, a mixed block and flow diagram of a system 700 is provided for accessing forecasting data, where the forecasting data has been determined using a neural network. In general terms, FIGS. 7A and 7B illustrate an embodiment of the invention where a retailer uses computer 702 to access forecasting apparatus 704 to initiate the determination of forecasting data and to view that forecasting data. In this embodiment, forecasting apparatus 704 is operated and maintained by a third party consultant that provides forecasting data to retailers. It will be understood that computer 702 is an embodiment of computing system 550 and forecasting apparatus 704 is an embodiment of forecasting apparatus 530.

In this embodiment of the invention, the retailer transmits sales data relating to the sale of Consumer Product Z to forecasting apparatus 704 via a web portal. Additionally, the retailer inputs, among other things, information relating to the advertising and promotion of Consumer Product Z via a web portal provided by forecasting apparatus 704. In this embodiment, the retailer interacts with forecasting apparatus 704 to obtain forecasting data relating to Consumer Product Z so the retailer can forecast the number of units of Consumer Product Z that it anticipates selling during specific weeks of the next 12 months based, in part on, historical and anticipated advertising and promotional schedules. It will be understood that the process flow illustrated in FIG. 7 is an embodiment of process flow 600 described in connection with FIG. 6.

As described in connection with FIG. 7, it will also be understood that the forecasting data may also be based upon other types of product information (besides the advertising and promotional schedules) that is transmitted to forecasting apparatus 704, including but not limited to, weather conditions (e.g., temperature, humidity, snowfall, etc.), raw materials prices, gasoline prices, the occurrence of holidays (e.g., Thanksgiving, Fourth of July), the occurrence of special events, information about product supply chains, population statistics (e.g., demographics data, population size data, population growth data, etc.), economic data (e.g., consumer spending, GDP, mean annual income, stock market prices, etc.), sponsorship data, or any other condition that might affect the price of a product or consumer demand for a product. This information may be obtained by the retailer based upon its own records, loyalty card information, third party sources (e.g., subscription sources, third-party websites, trade associations, journals, industry observers, etc.) and may comprise historical or prospective information.

In accordance with some embodiments, the computer 702 and forecasting apparatus 704 are operably and selectively connected to each over via one or more networks (not shown). The one or more networks may include telephone networks (e.g., cellular networks, CDMA networks, any wireline and/or wireless network over which communications to telephones and/or mobile phones are sent), local area networks (LANs), wide area networks (WANs), global area networks (GANs) (e.g., the Internet), and/or one or more other networks.

At block 706, the retailer uses computer 702 to connect to forecasting apparatus 704. In this embodiment, the retailer connects to forecasting apparatus 704 by using a web browsing application on computer 702 to connect to a web portal. The web portal provides a graphical user interface that allows the retailer to access the functionality of forecasting apparatus 704 through computer 702. In the embodiment of the invention described in relation to block 706, the retailer must enter a unique user name and password combination that was supplied by the third party consultant that operates forecasting apparatus 704.

At block 708, the retailer uploads sales data to forecasting apparatus 704 using computer 702. In this embodiment of the invention, the sales data represents the weekly quantity of 24-pack counts of Consumer Product Z sold during the past 52 weeks by all of the retailer's distribution outlets in a specific geographic retail marketing area. In this embodiment, the retailer uploads the sales data by using the functionality of the web portal. In the embodiment of the invention depicted at block 708, the retailer uploads the sales data to forecasting apparatus 704 using a wireless network. However, as one of skill in the art will appreciate, in other embodiments, retailer may use any other type of communications network. At block 710, the forecasting apparatus receives the sales data from computer 702. The forecasting apparatus 704 subsequently stores this sales data in a memory device at block 712.

At block 714, after uploading sales data to forecasting apparatus 704 (see block 708), the retailer uses computer 702 to input additional product information via the web portal. In this embodiment of the invention, the retailer inputs product information that comprises of (i) information about sales prices; (ii) information about advertising; (iii) information about promotions; (iv) information about weather; (v) economic information; and (vi) information about local activities in the specific geographic retail marketing area.

In this embodiment, the information about sales prices comprises several different types of information. The retailer inputs information describing the prices at which it sold Consumer Product Z during the past 52 weeks. Additionally, the retailer inputs information describing the prices at which other retailers, such as its competitors, sold Consumer Product Z during the same time period. Lastly, the retailer inputs information describing the prices at which it intends to sell Consumer Product Z during the next 52 weeks.

In this embodiment, the information about advertising comprises several different types of information. The retailer inputs information describing the types of advertisements it ran for Consumer Product Z during the past 52 weeks, such as print advertisements, television advertisements, radio advertisements, and internet advertisements. Additionally, the retailer inputs information describing the types of advertisements that other retailers, such as its competitors, ran for Consumer Product Z during the same time period. Lastly, the retailer inputs information describing the types of advertisements that it intends to run during the next 52 weeks.

Similarly, in this embodiment, the information about promotions comprises several different types of information. The retailer inputs information describing the types of promotions it ran for Consumer Product Z during the past 52 weeks, such as buy one get one free promotions or special pricing promotions. Additionally, the retailer inputs information describing the types of promotions that other retailers, such as its competitors, ran for Consumer Product Z during the same time period. Lastly, the retailer inputs information describing the types of promotions it plans to run for Consumer Product Z during the upcoming 52 weeks.

In this embodiment, the information about the weather comprises several different types of information. The retailer inputs information describing the weather during the preceding 52 weeks in which it sold Consumer Product Z. Additionally, the retailer may input information describing weather forecasts (e.g., predicted average temperatures, predicted rainfall, etc.) during all or any portion of the upcoming 52 weeks.

In this embodiment, the economic information comprises any type of information that may describe a factor that affects the sale of Consumer Product Z. For example, the retailer inputs information describing the price of gasoline, the value(s) of the stock market(s), interest rates, and retail spending data during the preceding 52 weeks in which it sold Consumer Product Z. Additionally, the retailer may input information describing the predicted price of gasoline, value of stock market(s), interest rates, and retail spending during all or any portion of the upcoming 52 weeks.

In this embodiment, the information about local events in the specific geographic retail marketing area comprises different types of information. The retailer inputs information describing various events that occurred during the preceding 52 weeks that may have affected the sales of Consumer Product Z, such as sporting events, festivals, school schedules, concerts, conventions, trade shows, etc. that occurred in the specific geographic retail marketing area. Additionally, the retailer may input information describing similar events that are scheduled to occur during all or any portion of the upcoming 52 weeks.

In some embodiments of block 714, the retailer may input other types of types of additional product information. As one of skill in the art will appreciate, the retailer may input any other types of additional product information that may affect the price of a Consumer Product Z or consumer demand for Consumer Product Z. Alternatively, in some embodiments, the retailer may input less types of additional product information. For example, in some alternative embodiments, the retailer might omit inputting any additional product information that describes the pricing, advertising, and promotional activities of its competitors.

At block 714, the retailer inputs all the additional product information using a web-based interface. This web-based interface may use any type of element to allow the retailer to input product information, including but not limited to dialog boxes, drop down lists, text boxes, radio buttons, and/or hyperlinks. FIG. 9 provides additional detail about the interface of the web portal that allows the retailer to communicate with forecasting apparatus 704.

At block 716, the forecasting apparatus receives the additional product information that the retailer inputted at block 714. At block 716, the forecasting apparatus 704 subsequently stores this product information in a memory device. In some embodiments, this additional product information may be combined with the sales data that that was stored at block 712. In other embodiments, this additional product information may be stored separately from the sales data.

At block 720, the retailer requests that the forecasting apparatus 704 use the product information that it received at blocks 710 and 716 to determine forecasting data. In this embodiment of the invention, the retailer makes this request via a web-based interface. At block 722 the forecasting apparatus receives this request. In some embodiments of the invention, the functions represented by blocks 720 and 722 may be optional steps. In other words, forecasting apparatus 704 may automatically begin determining forecasting data without having to wait for the retailer to make such a request.

At blocks 724 through 728 the forecasting apparatus 704 uses the product information that it received at blocks 710 and 716 to determine forecasting data. Blocks 724 through 728 represent an embodiment of the process flow described in connection with FIG. 2. At block 724, the forecasting apparatus 704 constructs a data matrix from the product information that it received at blocks 710 and 716. As indicated by the dashed line between block 712/718 and block 724, the step of constructing the data matrix requires the forecasting apparatus to access the product information that it stored in memory. In this embodiment, the data matrix is constructed by taking a logarithm of the values of the sales data that was received at block 710 and then centering such values (i.e., taking a standard deviation, etc.). As constructed, the data matrix represents a series of variables, where each variable represents a portion of the product information that the forecasting apparatus 704 received at blocks 710 and 716. In this embodiment, the data matrix contains variables that represent: (1) the weekly quantity of 24-packs of Consumer Product Z sold during the past 52 weeks by all of the retailer's distribution outlets in a specific geographic marketing area; (2) whether or not the retailer's distribution outlets ran print advertisements during each week in which Consumer Product Z was sold; (3) whether or not the retailer's competitors ran radio advertisements each week in which Consumer Product Z was sold; (4) whether or not the retailer was running a “buy quantity get quantity” promotion for Consumer Product Z during each week in which it was sold; (5) the “hot price” in which the retailer's competitors were selling Consumer Product Z during each week in which it was sold; and (6) the weekly high temperature in a specific geographic marketing area during each week in which Consumer Product Z was sold. As one of skill in the art will appreciate, the data matrix may include any additional variables that represent any other portion of the product information that the forecasting apparatus 704 received at blocks 710 and 716.

Although not depicted in FIG. 7, in some embodiments, forecasting apparatus 704 may store product information for other retailers that relates to those other retailers' sale of Consumer Product Z (e.g., the other retailers' planned future pricing for Consumer Product Z, the other retailers' planned advertising for Consumer Product Z, the other retailers' planned promotions for Consumer Product Z, etc.). As one of skill in the art will appreciate, such information (whether historical or prospective) may be unknown to the retailer that connects to forecasting apparatus 704 at block 706 but it may nonetheless be relevant to that retailer's forecasted sales of Consumer Product Z. Accordingly, in some embodiments, forecasting apparatus 704 may include this information about those other retailers' sale of Consumer Product Z in the data matrix that is constructed at block 724. In such embodiments, the information about those other retailers' sales of Consumer Product Z may not be disclosed to the retailer requesting the forecasting data (i.e., the retailer operating computer 702), but it may nonetheless be used by forecasting apparatus 704 to determine forecasting data.

Additionally, although not depicted in FIG. 7, in some embodiments, forecasting apparatus 704 may store product information for other retailers that relates to those other retailers' sale of one or more products that compete with (or otherwise affect the sale of) Consumer Product Z. For instance, forecasting apparatus 704 may store product information for other retailers that relates to those other retailers' sale of Consumer Product A, where the sale of Consumer Product A affects the sale of Consumer Product Z. The product information for Consumer Product A could comprise the other retailers' historical or planned future pricing for Consumer Product A, the other retailers' historical or planned advertising for Consumer Product A, the other retailers' historical or planned promotions for Consumer Product A, or any other type of product information relating to Consumer Product A As one of skill in the art will appreciate, such information about Consumer Product A may be unknown to the retailer that connects to forecasting apparatus at block 706 but it may nonetheless be relevant to that retailer's forecasted sales of Consumer Product Z. Accordingly, in some embodiments, forecasting apparatus 704 may include this information about those other retailers' sale of Consumer Product A in the data matrix that is constructed at block 724. In such embodiments, the information about those other retailers' sales of Consumer Product A may not be disclosed to the retailer requesting the forecasting data (i.e., the retailer operating computer 702), but it may nonetheless be used by forecasting apparatus 704 to determine more accurate forecasting data.

Lastly, in still some other embodiments (which are not depicted in FIG. 7), forecasting apparatus 704 may obtain and store product information relating to Consumer Product Z from additional third party sources, such as third party data feeds. Such third party data feeds may provide information (historical and/or prospective) such as weather conditions, economic conditions (e.g., stock market values, gas prices) or other types of data that affect the sale or demand of Consumer Product Z. The data feeds may provide this information as part of a continuous data stream, or at any other interval (e.g., daily, weekly, etc.). Accordingly, in some embodiments, forecasting apparatus 704 may include this third party information in the data matrix that is constructed at block 724. In such embodiments, the third party information may not be disclosed to the retailer requesting the forecasting data (i.e., the retailer operating computer 702), but it may nonetheless be used by forecasting apparatus 704 to determine more accurate forecasting data.

As described in the preceding three paragraphs, forecasting apparatus 704 may obtain, store, and use product information that is obtained from sources other than retailer that is requesting forecasting data from forecasting apparatus 704. For example, forecasting apparatus 704 may obtain such product information from (i) competitors of the retailer that is requesting forecasting data; and/or (ii) other third parties. Such product information may be transmitted to forecasting apparatus 704 in the form of a data stream. Regardless, in such embodiments, forecasting apparatus 704 may use this additional product information to construct a data matrix and determine forecasting data for the retailer that is requesting the forecasting data from forecasting apparatus 704. Thus, while a certain retailer may expect to forecast a certain number of sales based upon its pricing, marketing, and promotion plans, the existence of unknown competitive activity (or other activity from third parties) may nonetheless affect a retailer's sales forecast and provide an indication that third party activities are affecting the retailer's sales of a product.

Returning now to FIG. 7, at block 726, the forecasting apparatus 704 constructs the neural network that will be used to evaluate the data matrix and determine the forecasting data for the sale of Consumer Product Z. At block 726, the forecasting apparatus 726 constructs a neural network as described in connection with FIG. 1.

At block 728 the forecasting apparatus 704 evaluates the neural network constructed at block 726 with the data matrix from block 724. As described in connection with FIG. 2, through the use of mathematical transformations, this data matrix can be transformed into a format that can be used in connection with the input units of the neural network input layer. At block 730, the forecasting apparatus 704 stores the forecasting data for the sale of Consumer Product Z, as determined at block 728, in memory.

Turning now to FIG. 7B, which is a continuation of FIG. 7A, at block 732, the retailer requests to view the forecasting data for Consumer Product Z. In this embodiment of the invention, the retailer makes this request via a web-based interface. In some embodiments, the retailer can request to view all forecasting data, and in other embodiments, the retailer can request to see only a portion of the forecasting data, such as forecasting data for a particular time period. At block 734 the forecasting apparatus receives this request and at block 736 the forecasting data is displayed to the retailer. In this embodiment of the invention, forecasting apparatus 704 displays the forecasting data to the retailer via the web based interface. The dashed line connecting blocks 730 and 736 indicates that in order to display the forecasting data, forecasting apparatus 704 must access the forecasting data that it stores in memory at step 730.

At block 738, the retailer views the forecasting data. The forecasting data that the retailer views at block 738 allows the retailer to view sales forecasts for Consumer Product Z based upon the product information that the forecasting apparatus 704 received at blocks 710 and 716, as well as any other product information to which forecasting apparatus 704 may otherwise have access. This forecasting data is accessible to the retailer via the use of a web browsing functionality of computer 702. In this embodiment of the invention, the forecasting data is presented to the retailer in a format similar to forecasting data described in FIG. 3. In some embodiments of the invention, the retailer may download the forecasting data to computer 702. Additionally, the retailer may email or otherwise transmit the forecasting data to third parties, such as manufacturers, vendors, and/or individuals associated with the manufacturing, marketing or promotion of Consumer Product Z (e.g., advertising agencies, PR companies, etc.).

Although not illustrated in FIG. 7, in some embodiments of the invention, the retailer may be able to use the forecasting data as part of its own internal electronic processes. For instance, the retailer could import the forecasting data into its sales or reporting databases, import the forecasting data into the computing systems that control the production of Consumer Product Z or use the forecasting data in connection with any other electronic, computerized, or automated business processes that are used by the retailer.

At optional block 740, the retailer may edit, delete, or change all or portions of the product information submitted to the forecasting apparatus 704 at block 708 and 714 in order to view how such edits, deletions, or changes affect the forecasting data. For example, the retailer may decide to use a different advertising strategy for Consumer Product Z during the upcoming 2 months (e.g., radio advertisements as opposed to print advertisements). Alternatively, the retailer may decide to use a different promotion strategy for Consumer Product Z during the upcoming 2 months (e.g., loyalty card promotions as opposed to “buy quantity get quantity” promotions). The retailer may make these changes using a web based interface and although not shown in FIG. 7, the forecasting apparatus 704 will (either dynamically or upon the retailer's request) re-determine the forecasting data based upon the modified product information by constructing a new data matrix (see block 724), evaluating the neural network with the new data matrix (see block 728), and storing the forecasting data in memory (see block 730). Although not depicted in connection with block 740, the user may also add new product information that may be relevant to the sales of Consumer Product Z or delete product information. Further the edited, changed, or added product information may be stored as a new data matrix or the previous data matrix (that was constructed at block 724) may be supplemented with the edited, changed, or added product information from this block 740.

By enabling the retailer to edit, delete, or change all or portions of the product information, the retailer can evaluate how different advertising and/or promotional scenarios (or any other changed conditions) might affect the sales forecast for Consumer Product Z in real-time or without any significant delay. This approach is significantly different than current systems, which approach the solution with a more standardized statistical method of forecasting—that is, a static model built on environmental variables at the moment of inception, rather than a dynamic approach (as described in connection with FIG. 1) that constantly changes the neural network to reflect current pricing and demand conditions.

Lastly, at optional block 742, the retailer may view the relevance of the variables in the data matrix (as constructed by forecasting apparatus 704) to the forecasting data. At block 745, the retailer may use a web based interface to view the relevance data, which the forecasting apparatus 704 calculates according to the method described in connection with block 250 of FIG. 2 and stores in memory (not shown in FIG. 7B). By viewing the relevance data, the retailer can identify which data matrix variables have the greatest effect of the forecast sales of Consumer Product Z. For example, based upon the data matrix variable described in connection with block 724, the retailer might determine that the decision whether or not to run a “buy quantity get quantity” promotion for Consumer Product Z has the greatest effect on the future sales of Consumer Product Z. Thus, based upon this relevant information, the retailer can make a more informed decision as to the type of promotions it will run in the future.

As one of skill in the art will appreciate, the process flow depicted in FIG. 7 may be repeated by the retailer at any interval of time. For instance, in some embodiments of the invention, the retailer may supply forecasting apparatus 704 with a continuous stream of sales data for Consumer Product Z, which would replace the one-time uploading of sales data that is depicted in block 708. In other embodiments, the retailer may supply forecasting apparatus 704 with sales data on a daily, weekly, monthly, etc. basis. Furthermore, the retailer may regularly input additional product information to forecasting apparatus 704 at various intervals. For example, the retailer may, on a weekly basis, input its updated advertising and/or promotion schedule for Consumer Product Z into forecasting apparatus 704. Whenever forecasting apparatus 704 determines new forecasting data based upon this updated product information (whether automatically or upon the request of retailer), the new forecasting data will be more accurate. Further the forecasting apparatus 704 adapts by comparing its forecasting data to actual sales during a certain period of time. As discussed in relation to FIG. 1, through the continual comparison of sales forecasts to actual sales (as well as the continual input of product information), the neural network is able to learn which variables and conditions have a greater effect on the sale of the product, and thus, produce forecasting data with greater accuracy.

### C. Example No. 2

### Use by Manufacturer

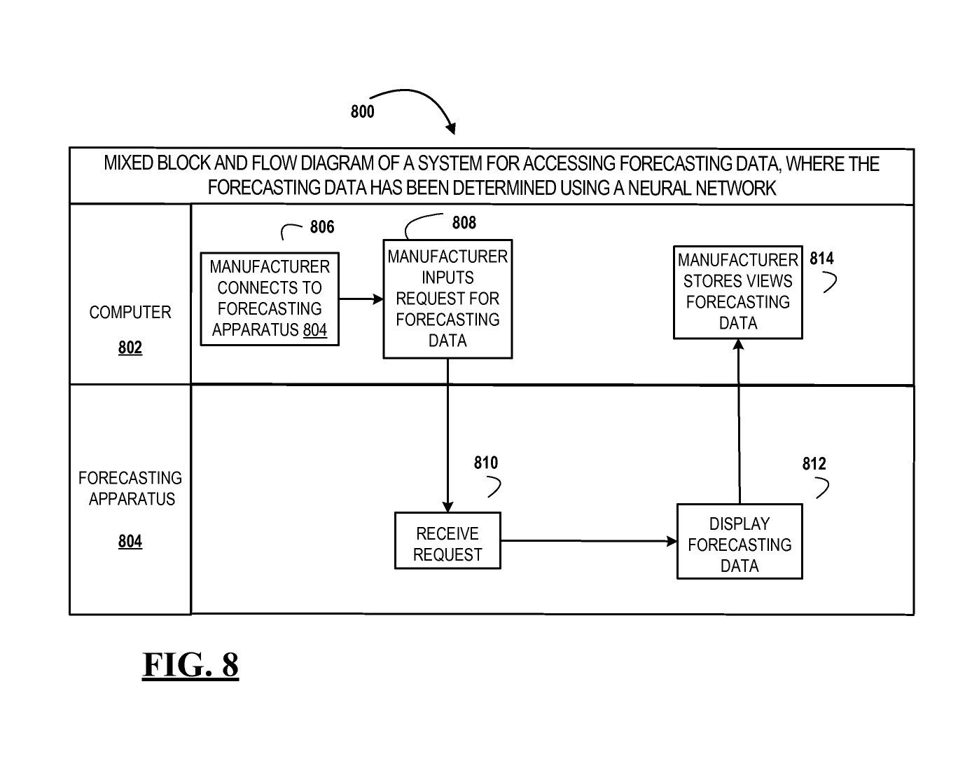

Referring now to FIG. 8, a mixed block and flow diagram of a system 800 is provided for accessing forecasting data, where the forecasting data has been determined using a neural network. In general terms, FIG. 8 illustrates an embodiment of the invention where a manufacturer uses computer 802 to access forecasting apparatus 804 to obtain forecasting data for the sales of a product. Forecasting apparatus 804 is used by a third party consultant that provides forecasting data to manufacturers. It will be understood that computer 802 is an embodiment of computing system 550 and forecasting apparatus 804 is an embodiment of forecasting apparatus 530. In this embodiment of the invention, the manufacturer makes and distributes Consumer Product Y to a retailer. The retailer then sells Consumer Product Y in its stores. Additionally, the retailer uses forecasting apparatus 804 in the manner described in FIG. 7 to obtain forecasting data for Consumer Product Y. Thus, in this embodiment of the invention, manufacturer seeks to access apparatus 804 to view the forecasting data for Consumer Product Y so that it can anticipate how many units of Consumer Product Y it will need to make in order to keep up with the forecasted sales of the product. It will be understood that the process flow illustrated in FIG. 8 is an embodiment of process flow 600 described in connection with FIG. 6.

In accordance with some embodiments, the computer 802 and forecasting apparatus 804 are operably and selectively connected to each other via one or more networks (not shown). The one or more networks may include telephone networks (e.g., cellular networks, CDMA networks, any wireline and/or wireless network over which communications to telephones and/or mobile phones are sent), local area networks (LANs), wide area networks (WANs), global area networks (GANs) (e.g., the Internet), and/or one or more other networks.

At block 806, the manufacturer uses computer 802 to connect to forecasting apparatus 804. In this embodiment, the manufacturer connects to forecasting apparatus 804 by using a web browsing application on computer 802 to connect to a web portal. The web portal provides a graphical user interface that allows the manufacturer to access the functionality of forecasting apparatus 804 through computer 802. In the embodiment of the invention described in relation to block 806, the manufacturer must enter a unique user name and password combination that was supplied by the third party consultant that operates forecasting apparatus 804. In some embodiments of the invention, the retailer must authorize the manufacturer to receive a user name and password to access forecasting apparatus 804.

At block 808, the manufacturer requests to view the forecasting data for Consumer Product Y from forecasting apparatus 804. This forecasting data was calculated by forecasting apparatus 804 using product information provided to it by the retailer in accordance with the process flow of FIG. 7. In this embodiment of the invention, the manufacturer makes this request via a web-based interface through the use of a hyperlink. At block 810 the forecasting apparatus 804 receives this request and at block 812, the forecasting data is displayed to the manufacturer. In this embodiment of the invention, forecasting apparatus 804 displays the forecasting data to the manufacturer via the web based interface.

At block 814, the manufacturer views the forecasting data. The forecasting data that the manufacturer views at block 814 allows the manufacturer to view sales forecasts for Consumer Product Y based upon the product information that the forecasting apparatus 804 received from the retailer. This forecasting data is accessible to the manufacturer via the use of a web browsing functionality of computer 802. In this embodiment of the invention, the forecasting data is presented to the manufacturer in a format similar to forecasting data described in FIG. 3. In some embodiments of the invention, the manufacturer may download the forecasting data to computer 802. Additionally, the manufacturer may email or otherwise transmit the forecasting data to third parties, such as retailers, suppliers, and/or individuals associated with the manufacturing, marketing or promotion of Consumer Product Y.

By performing the process flow depicted in FIG. 8, the manufacturer can anticipate the number of units of Consumer Product Y that is needs to manufacture in order to keep up with forecasted sales. To the extent the manufacturer's current output is less than forecasted sales, the manufacturer can increase the number of hours in which it manufactures Consumer Product Y, hire additional employees, increase employee shift, anticipate needs for raw products, and/or take any other additional measures to increase the output of Consumer Product Y to meet the forecasted sales. Alternatively, to the extent the manufacturer is producing more units of Consumer Product Y than necessary based on the forecasted sales, the manufacturer can take steps to decrease the output of Consumer Product Y. Thus by practicing the process flow of FIG. 8, the manufacturer can ensure that there are neither any shortages of Consumer Product Yin any of the retailer's locations nor surplus units of Consumer Product Y that go unsold prior to their expiration dates. Thus, as one of skill in the art will appreciate, a manufacturer may use the process flow of FIG. 8 to manage its supply chain with greater efficiency.

While the process flow of FIG. 8 represents and embodiment where the manufacturer makes and distributes Consumer Product Y to a single retailer, in another embodiments, the manufacturer could make and distribute Consumer Product Y to multiple locations of a retailer (e.g., a chain retailer). In such embodiments, the forecasting data that the manufacturer views via forecasting apparatus 704 could be based upon the cumulative product information provided by all of the locations of the single retailer.

### V. User Interface of Web Portal Application

FIG. 9 represents a depiction of a user interface, or interface 900 that is accessible to a user that remotely accesses portal application 545. In particular, interface 900 represents an embodiment of the web-based interface that may be used by a retailer to input product information and sales data to forecasting apparatus 530. As described above, forecasting apparatus 530 may then use this product information to calculate forecasting data.

Interface 900 includes Retailer Name 901, which is the name of the retailer that is authorized to access portal application 545. Additionally, as depicted in FIG. 9, interface 900 allows the retailer to input information relating to Product 902 and Product 906. Product 902 and Product 906 are two different products that are sold by the retailer. In this embodiment, the retailer may input product information relating to Product 902 and Product 906 in order to facilitate the calculation of forecasting data for those two products using a neural network.

As depicted in interface 900, the retailer can input various product information relating to Product 902, such as retail price 903, advertisement type 904, and promotion type 905. As shown in interface 900, the retailer can input this information for various periods of time, such as Week 990, Week 991, and Week 992. Weeks 990-992 might be weekly periods that have already passed, they may be weekly periods that will occur in the future, they may include the present weekly period, or they may include a combination of the foregoing. As one of skill in the art will appreciate, in other embodiments, the retailer could input product information for different periods of time (e.g., days, months, years, fiscal quarters, etc.) Additionally, as depicted in interface 900, the retailer may input product information relating to Product 906, including retail price 907, advertisement type 908, and promotion type 909, for the same period of time (i.e., Weeks 990-992).

In fields 910-912, the retailer can input the retail price 903 of Product 902 for each of Week 990, Week 991, and Week 992. In this embodiment of the invention, retail price 903 is the price at which the retailer sold Product 902 during each of Week 990, Week 991, and Week 992. Fields 910-912 may be text input boxes, drop down boxes, scrolling selection boxes or any other type of web element (e.g., hyperlinks, etc.) that would allow the retailer to input the relevant retail price 903 into fields 910-912. Retail price 907 is similar to retail price 903, except that it is the price at which the retailer sold Product 906 during each of Week 990, Week 991, and Week 992. As one of skill in the art will appreciate, fields 940-942 allow the retailer to similarly input the retail price 907 for Product 906 during each of Week 990, Week 991, and Week 992.

In fields 920-922, the retailer can input the advertisement type 904 for Product 902 for each of Week 990, Week 991, and Week 992. In this embodiment of the invention, advertisement type 904 is the type of advertisement (if any) that the retailer ran for Product 902 during each of Week 990, Week 991, and Week 992. Advertisement type 904 may comprise an internet advertisement, a print advertisement, a television advertisement, a radio advertisement, or any other type or combination of advertisements that the retailer may use for Product 904. Fields 920-922 may be text input boxes, drop down boxes, scrolling selection boxes or any other type of web element (e.g., hyperlink, etc.) that would allow the retailer to input the relevant advertisement type 904 into fields 920-922. Advertisement type 908 is similar to advertisement type 904, except that it is the type of advertisement that the retailer ran for Product 906 during each of Week 990, Week 991, and Week 992. As one of skill in the art will appreciate, fields 950-952 allow the retailer to similarly input the advertisement type 908 for Product 906 during each of Week 990, Week 991, and Week 992.

In fields 930-932, the retailer can input the promotion type 905 for Product 902 for each of Week 990, Week 991, and Week 992. In this embodiment of the invention, promotion type 905 is the type of promotion (if any) that the retailer ran for Product 902 during each of Week 990, Week 991, and Week 992. Promotion type 905 may comprise any type of promotion including, buy a certain quantity of products to get a certain price; buy a certain quantity of products to get a certain number free; daily, weekly, or monthly special prices; promotions through the use of certain payment methods; promotions through the use of customer loyalty cards. Fields 930-932 may be text input boxes, drop down boxes, scrolling selection boxes or any other type of web element (e.g., hyperlink, etc.) that would allow the retailer to input the relevant promotion type 905 into fields 930-932. Promotion type 909 is similar to promotion type 905, except that it is the type of promotion that the retailer ran for Product 907 during each of Week 990, Week 991, and Week 992. As one of skill in the art will appreciate, fields 960-962 allow the retailer to similarly input the promotion type 909 for Product 907 during each of Week 990, Week 991, and Week 992.

As one of skill in the art will appreciate, interface 900 may include any other functionality to input any other type of product information. For instance, interface 900 may include text input boxes, drop down boxes, scrolling selection boxes or any other type of web element (e.g., hyperlinks, etc.) that would enable the retailer to enter (i) information about how competitors of the retailer priced Product 902 or Product 906; (ii) information about advertisements and/or promotions that competitors of the retailer ran for Product 902 or Product 906; (iii) information about weather conditions; (iv) or any other type of product information that is associated with Product 902 or Product 906 (e.g., information about competitive products, complementary products, inverse products, economic information, gas prices, stock market prices, etc.). Additionally, as one of skill in the art will appreciate, interface 900 may allow the retailer to input product information for any number of time periods, not just Weeks 990-992. For instance, interface 900 might enable the retailer to input product information for fifty two weeks. Further, interface 900 may include functionality that allows the retailer to provide product information directly from a data feed or subscription service directly to forecasting apparatus 530.

Interface 900 also includes an Input Sales Data button 970. By clicking on this button (i.e., using a mouse, pointer, key board or other input device), the retailer can upload sales data relating to Product 902 and/or Product 906 to forecasting apparatus 530. Additionally, interface 900 includes View Forecasting Data button 980. By clicking on this button, the retailer can prompt forecasting apparatus 530 to calculate forecasting data based on the product information that the retailer inputted in fields 910-912, 920-922, 930-932, 940-942, 950-952, and 960-962, as well as the sales data that the retailer uploads in connection with Input Sales Data button 970, and view the resulting forecasting data. Alternatively, in embodiments of the invention where forecasting apparatus 530 automatically calculates forecasting data whenever the retailer uploads product information, pressing View Forecasting Data button 980 simply allows the retailer to view the forecasting data. Interface 900 also includes a View Relevance Data button 990. By clicking on this button, the retailer can view the relevance data for each of the data matrix variables that were used to determine the forecasting data (see FIG. 2, Block 250). As one of skill in the art will appreciate, Input Sales Data button 970, View Forecasting Data button 980, and View Relevance Data button 990 may alternatively be displayed as hyperlinks or any other type of web element.

While some embodiments of the present invention have been described where a retailer provides product information, which is used to determine forecasting data using a neural network, it should be understood that any individual or entity may provide product information in connection with the determination of forecasting data, including but not limited to manufacturers, common carriers, distributors, marketing companies, public relations companies, advertising companies or end users. The present invention should not be limited to embodiments where a retailer is the only type of entity that provides product information to a forecasting apparatus in connection with the determination of forecasting data. Any combination and number of individuals and/or entities may simultaneously provide product information to a forecasting apparatus in connection with the determination of forecasting data based on that product information.

Additionally, it should be understood that any individual or entity (not just retailers and manufacturers) may access a forecasting apparatus to request the determination of forecasting data and to view that forecasting data, including but not limited to manufacturers, common carriers, distributors, marketing companies, public relations companies, advertising companies or end users. The present invention should not be limited to embodiments where a retailer is the only type of entity that accesses a forecasting apparatus to request the determination of forecasting data and to view that data. Any combination and number of individuals and/or entities may simultaneously access a forecasting apparatus to request the determination of forecasting data and to view that forecasting data.

In general terms, although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart (s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. An apparatus for forecasting sales of a product by a user, the apparatus comprising:
a communication device;
a processing device communicably coupled to the communication device, wherein the processing device is configured to:
receive first product information that comprises the following components: information about historical and future prices of the product, information about historical and future promotions for the sale of the product, information about historical and future advertisements for the sale of the product, and information about historical and future weather conditions;
generate a first function u(n) that comprises variables that represent each component of the first product information;
generate a first neural network comprising an input layer, a dynamic reservoir that has at least 500 state units, a readout layer, and a weighted feedback connection from the readout layer to the dynamic reservoir, wherein the input layer is connected to the dynamic reservoir through a weighted input matrix Wᵢₙ, the dynamic reservoir is weighted according to a matrix Wᵣₑₛₑᵣᵥₒᵢᵣ, the dynamic reservoir is connected to the readout layer through a weighed output matrix Wₒᵤₜ, the weighted feedback connection is weighted according to a matrix W_{feedback}, and a value x(n) of the dynamic reservoir for the first function u(n) is equal to:
x(n)=tan h(Wᵢₙu(n)+Wᵣₑₛₑᵣᵥₒᵢᵣ(n−1)+W_{feedback}(n−1))
input the first function u(n) into the first neural network to generate, via the first neural network, a first sales forecast, wherein the first sales forecast projects the sale of the product over a first time period and is at least partially based on the first product information;
present the first sales forecast to the user;
receive first sales data representing actual sales of the product during the first time period; and
modify the value of at least one of Wᵢₙ, Wᵣₑₛₑᵣᵥₒᵢᵣ, Wₒᵤₜ or W_{feedback} based on a comparison of the first sales data to the first sales forecast to generate a second neural network, wherein inputting the first function u(n) into the second neural network generates a second sales forecast that has a deviation from the first sales data that is less than the deviation between the first sales forecast and the first sales data.

2. The apparatus of claim 1, wherein the first product information is provided by the user.

3. The apparatus of claim 1, wherein the first product information is provided by at least one third party source.

4. The apparatus of claim 2, wherein the user is a party that performs at least one of the selling of the product or the manufacturing of the product.

5. The apparatus of claim 1, wherein the processing device is further configured to receive second product information that is different than the first product information and comprises at least one of the following components: information about future promotions for the sale of the product, information about future advertisements for the sale of the product, information about the future price of the product, and information about future weather conditions.

6. The apparatus of claim 5, wherein the processing device is further configured to generate a second data matrix that comprises variables that represent each component of the second product information.

7. The apparatus of claim 5, wherein the processing device is further configured to generate, via the neural network, a third sales forecast, wherein the third sales forecast is different than the first and second sales forecasts and is at least partially based on the second product information.

8. The apparatus of claim 1, wherein the processing device is further configured to provide a web portal, wherein the web portal comprises a secure website where the user can upload sales data relating to the product, input descriptions of historical and future advertisements for the product; input descriptions of historical and future promotions for the sale of the product, input historical and future prices for the product, and input information about historical and future weather conditions.

9. The apparatus of claim 1, wherein the processing device is further configured to dynamically change the neural network based at least in part on the receipt of the first sales data.

10. The apparatus of claim 1, wherein the processing device is further configured to permute the value of the at least one variable of the first data matrix to determine the effect of the at least one variable on the first sales forecast.

11. A computer implemented method for forecasting sales of a product by a user, the computer implemented method comprising:
providing a processing device executing computer readable code structured to cause the processing device to:
receive first product information that comprises the following components: information about historical and future prices of the product, information about historical and future promotions for the sale of the product, information about historical and future advertisements for the sale of the product, and information about historical and future weather conditions;
generate a first function u(n) that comprises variables that represent each component of the first product information;
generate a first neural network comprising an input layer, a dynamic reservoir that has at least 500 state units, a readout layer, and a weighted feedback connection from the readout layer to the dynamic reservoir, wherein the input layer is connected to the dynamic reservoir through a weighted input matrix Wᵢₙ, the dynamic reservoir is weighted according to a matrix Wᵣₑₛₑᵣᵥₒᵢᵣ, the dynamic reservoir is connected to the readout layer through a weighed output matrix Wₒᵤₜ, the weighted feedback connection is weighted according to a matrix W_{feedback}, and a value x(n) of the dynamic reservoir for the first function u(n) is equal to:
x(n)=tan h(Wᵢₙu(n)+Wᵣₑₛₑᵣᵥₒᵢᵣ(n−1)+W_{feedback}(n−1))
input the first function u(n) into the first neural network to generate, via the first neural network, a first sales forecast, wherein the first sales forecast projects the sale of the product over a first time period and is at least partially based on the first product information;
present the first sales forecast to the user;
receive first sales data representing actual sales of the product during the first time period; and
modify the value of at least one of Wᵢₙ, Wᵣₑₛₑᵣᵥₒᵢᵣ, Wₒᵤₜ, or W_{feedback} based on a comparison of the first sales data to the first sales forecast to generate a second neural network, wherein inputting the first function u(n) into the second neural network generates a second sales forecast that has a deviation from the first sales data that is less than the deviation between the first sales forecast and the first sales data.

12. The method of claim 11, wherein receiving first product information comprises receiving first product information provided by the user.

13. The method of claim 11, wherein receiving first product information comprises receiving first product information provided by at least one third party source.

14. The method of claim 12, wherein receiving first product information provided by the user comprises receiving first product information from a party that performs at least one of selling of the product or manufacturing of the product.

15. The method of claim 11, further comprising the step of providing computer readable code structured to cause the processing device to receive second product information that is different than the first product information and comprises at least one of the following components: information about future promotions for the sale of the product, information about future advertisements for the sale of the product, information about the future price of the product, and information about future weather conditions.

16. The method of claim 15, further comprising the step of providing computer readable code structured to cause the processing device to generate a second data matrix that comprises variables that represent each component of the second product information.

17. The method of claim 15, further comprising the step of providing computer readable code structured to cause the processing device to generate, via the neural network, a third sales forecast, wherein the third sales forecast is different than the first and second sales forecasts and is at least partially based on the second product information.

18. The method of claim 11, further comprising the step of providing computer readable code structured to cause the processing device to provide a web portal, wherein the web portal comprises a secure website where the user can upload sales data relating to the product, input descriptions of historical and future advertisements for the product; input descriptions of historical and future promotions for the sale of the product, input historical and future prices for the product, and input information about historical and future weather conditions.

19. The method of claim 11, further comprising the step of providing computer readable code structured to cause the processing device to dynamically change the neural network based at least in part on the receipt of the first sales data.

20. The method of claim 11, further comprising the step of providing computer readable code structured to cause the processing device to permute the value of the at least one variable of the first data matrix to determine the effect of the at least one variable on the first sales forecast.

21. A computer program product for forecasting sales of a product by a user, the computer program product comprising a non-transitory computer-readable medium, wherein the non-transitory computer-readable medium comprises computer executable program code store therein, the computer executable program code comprises:
a first executable portion configured to receive first product information that comprises the following components: information about historical and future prices of the product, information about historical and future promotions for the sale of the product, information about historical and future advertisements for the sale of the product, and information about historical and future weather conditions;
a second executable portion configured to generate a first function u(n) that comprises variables that represent each component of the first product information;
a third executable portion configured to generate a first neural network comprising an input layer, a dynamic reservoir that has at least 500 state units, a readout layer, and a weighted feedback connection from the readout layer to the dynamic reservoir, wherein the input layer is connected to the dynamic reservoir through a weighted input matrix Wᵢₙ, the dynamic reservoir is weighted according to a matrix Wᵣₑₛₑᵣᵥₒᵢᵣ, the dynamic reservoir is connected to the readout layer through a weighed output matrix Wₒᵤₜ, the weighted feedback connection is weighted according to a matrix W_{feedback}, and a value x(n) of the dynamic reservoir for the first function u(n) is equal to:
x(n)=tan h(Wᵢₙu(n)+Wᵣₑₛₑᵣᵥₒᵢᵣ(n−1)+W_{feedback}(n−1));
a fourth executable portion configured to input the first function u(n) into the first neural network to generate, via the first neural network, a first sales forecast, wherein the first sales forecast projects the sale of the product over a first time period and is at least partially based on the first product information;
a fifth executable portion configured to present the first sales forecast to the user;
a sixth executable portion configured to receive first sales data representing actual sales of the product during the first time period; and
a seventh executable portion configured to modify the value of at least one of Wᵢₙ, Wᵣₑₛₑᵣᵥₒᵢᵣ, Wₒᵤₜ, or W_{feedback} based on a comparison of the first sales data to the first sales forecast to generate a second neural network, wherein inputting the first function u(n) into the second neural network generates a second sales forecast that has a deviation from the first sales data that is less than the deviation between the first sales forecast and the first sales data.

22. The computer program product of claim 21, wherein the first product information is provided by the user.

23. The computer program product of claim 21, wherein the first product information is provided by at least one third party source.

24. The computer program product of claim 22, wherein the user is a party that performs at least one of the selling of the product or the manufacturing of the product.

25. The computer program product of claim 21, further comprising an eighth executable portion configured to receive second product information that is different than the first product information and comprises at least one of the following components: information about future promotions for the sale of the product, information about future advertisements for the sale of the product, information about the future price of the product, and information about future weather conditions.

26. The computer program product of claim 25, further comprising a ninth executable portion configured to generate a second data matrix that comprises variables that represent each component of the second product information.

27. The computer program product of claim 25, further comprising a ninth executable portion configured to generate, via the neural network, a third sales forecast, wherein the third sales forecast is different than the first and second sales forecasts and is at least partially based on the second product information.

28. The computer program product of claim 21, further comprising an eighth executable portion configured to provide a web portal, wherein the web portal comprises a secure website where the user can upload sales data relating to the product, input descriptions of historical and future advertisements for the product; input descriptions of historical and future promotions for the product, input historical and future prices for the product, and input information about historical and future weather conditions.

29. The computer program product of claim 21, further comprising an eighth executable portion configured to dynamically change the neural network based at least in part on the receipt of the first sales data.

30. The computer program product of claim 21, further comprising a eighth executable portion configured to permute the value of the at least one variable of the first data matrix to determine the effect of the at least one variable on the first sales forecast.

31. (canceled)

32. (canceled)

33. The apparatus of claim 1, wherein the first product information further comprises competing product information that includes information about at least one of the sale, price, promotion or advertisement of a competing product, wherein the competing product is sold by a retailer that competes with the user and further wherein the retailer that competes with the user provides the competing product information to the apparatus.

34. The apparatus of claim 33, wherein the competing product information is neither known to the user nor made available to the user.
